(19) United States
(12) Patent Application Publication
(10) Pub. No.: US 2017/0270417 A1
(43) Pub. Date: Sep. 21, 2017

(54) INFORMATION PROCESSING APPARATUS, INFORMATION PROCESSING SYSTEM, COMPUTER-READABLE RECORDING MEDIUM, AND INFORMATION PROCESSING METHOD

(71) Applicant: FUJITSU LIMITED, Kawasaki-shi (JP)

(72) Inventor: Yasuhiro Watanabe, Kawasaki (JP)

(73) Assignee: FUJITSU LIMITED, Kawasaki-shi (JP)

(21) Appl. No.: 15/421,476

(22) Filed: Feb. 1, 2017

(30) Foreign Application Priority Data
Mar. 15, 2016 (JP) 2016-050640

(51) Int. Cl. G06N 5/04

(52) U.S. Cl. CPC G06N 5/045

(57) ABSTRACT

Partial reconfigurable regions each perform a process by using, from among a plurality of functional modules, a functional module arranged in each of the partial reconfigurable regions, respectively. An arrangement decision unit decides, on the basis of the maximum operation frequency for each of the partial reconfigurable regions in a case where each of the functional modules is arranged in each of the partial reconfigurable regions, the arrangement of the functional module into each of the partial reconfigurable regions. An arrangement processing unit arranges the functional modules in the partial reconfigurable regions on the basis of the arrangement decided by the arrangement decision unit.

### CROSS-REFERENCE TO RELATED APPLICATION

This application is based upon and claims the benefit of priority of the prior Japanese Patent Application No. 2016-050640, filed on Mar. 15, 2016, the entire contents of which are incorporated herein by reference.

### FIELD

The embodiments discussed herein are related to an information processing apparatus, an information processing system, a computer-readable recording medium, and an information processing method.

### BACKGROUND

Information processing apparatuses, such as servers or the like have been improved their performance by setting, for example, a central processing unit (CPU) as a multi-core CPU. In contrast, in recent years, as a method of performing processes that is difficult to be processed by only the CPU, a field programmable gate array (FPGA) that is hardware in which the function can be changed has been drawing attention. Namely, an attempt is performed to increase the performance by mounting, in addition to a CPU, an FPGA to a server. Studies have been conducted on the introduction of, with respect to, for example, data centers, general purpose calculation servers that use such FPGAs.

In an FPGA, it is possible to reconfigure, from the current hardware configuration, the hardware configuration newly mapped in accordance with the requested function or performance. Furthermore, it is possible for the FPGA to rewrite a portion thereof in a state FPGA is in operation, which is called as dynamic reconfiguration or partial reconfiguration. In general purpose calculation servers that utilize the function of the dynamic reconfiguration of the FPGA, the FPGA has the following characteristics as a method of generally improving the performance. As a characteristic, the FPGA has a plurality of regions that can be reconfigured and each of the circuit modules can be arranged in any regions that can be reconfigured. Furthermore, as another characteristic, the FPGA has a characteristic that a plurality of a certain type of circuit modules is mounted in accordance with the requested performance.

It is assumed that, in some FPGA that has a plurality of reconfigurable regions, for example, a fixed region (static region) and a plurality of partial reconfigurable regions (PRRs) are present. Furthermore, it is assumed that, in some FPGA, various kinds of functions are implemented from a combination of partial reconfigurable modules (PRMs) that are circuit modules to be mounted. The PRM can be arranged in each of the PRRs by writing configuration data to a configuration memory that is associated with each of the PRRs. The configuration data is data obtained by converting IP (intellectual property) that is a library of a circuit module to a physical image. More specifically, the configuration data is converted to a bit stream and then sent to an FPGA.

As indicated by the characteristic described above, the PRM can be arranged in any PRRs. For example, general-purpose bus circuits are constituted in fixed regions around all of the PRRs and each of the PRMs can be connected to a bus even if the PRMs are arranged in any PRRs because each of the PRMs has a common interface such as a general-purpose bus or the like. Here, it is assumed that each of the PRRs is operated at the same frequency. Thus, asynchronous clock crossing is not requested between the PRMs and the common unit such as interconnect and a control unit.

Furthermore, if the resources of each of the PRRs are the same, configuration data with the same content can be used even if the PRM is arranged in any PRRs. Thus, if pieces of the configuration data in the PRRs are the same, by changing location information and the check sum of the PRRs to be arranged, it is possible to create a bit stream that is in accordance with the location of each of the PRRs.

If each of the PRRs is operated at the same frequency, the logical operation of the PRMs is the same even if the PRMs are arranged in any of the PRRs and superiority or inferiority of the logical operation does not basically occur. In this way, because superiority or inferiority does not occur for the PRMs even if the PRMs are arranged in any of the PRRs, if a free PRR is present, the PRM can be arranged in any of the free PRRs. Furthermore, if a free PRR is not present, several methods are present for replacing which one of the PRRs in each of which a PRM has already been arranged is replaced with a new PRM. For example, by invalidating the PRM that has a low possibility of being used, the PRR in which the subject PRM was arranged is made to be free. In this case, the PRM that has a low possibility of being used is decided by using a task scheduler.

Furthermore, even if a plurality of PRMs is used in an FPGA, the maximum operation frequency of the PRMs is uniquely decided. In general, the smallest value of the maximum operation frequency of the arranged PRR is guaranteed as the maximum operation frequency of the PRM.

However, the maximum operation frequency that can be operated may sometimes differ depending on the PRR to be arranged even if the same PRM is used. The following reason can be considered as the reason for this. For example, the length of the path from the input/output (I/O) terminal of each of the PRRs to a flip-flop (FF) that is present in a fixed region is different depending on the circuit mapped in the fixed region. Furthermore, with an FPGA having multiple die configurations, such as Xilinx (registered trademark) Stacked Silicon Interconnect (SSI) structure or the like, a cell speed differs due to a difference of the process condition or variation in the performance between dies. Furthermore, because the resources that can be used in each of the PRRs may sometimes differ, the results of the mapping in the PRRs may sometimes differ even if the same functional IP is used. A case in which the resources that can be used differs is a case in which a defective element is present in the PRR and the mapping is performed without using the defective element or a case in which the same resource is not allocated to each of the PRR regions. In this case, a bit stream is separately created for each PRR.

Furthermore, as a technology of arranging circuit modules in an FPGA, there is a conventional technology that appropriately set an operation mode of a basic logic cell circuit and a connection switch circuit in accordance with the operating state of the basic logic cell circuit. Furthermore, there is a conventional technology of a reconfigurable circuit that sets the operating characteristic of a transistor for each partial circuit of a circuit configuration circuit or a circuit wiring circuit.

Patent Document 1: Japanese Laid-open Patent Publication No. 2007-82017

Patent Document 2: International Publication Pamphlet No. WO 2009/123090

In contrast, the maximum operation frequency is uniquely set in each of the PRMs. For example, if a single PRM is mapped in a PRR, the maximum operation frequency corresponds to the maximum operation frequency of the subject PRM. In contrast, a plurality of RPMs are mapped in a single PRR, the smallest frequency from among the maximum operation frequencies of the mapped PRMs is set as the maximum operation frequency of all of the PRMs that are mapped in the subject PRR.

In this way, regarding each of the PRMs, the maximum operation frequency that can be operated may sometimes vary due to the PRR that is used for the mapping. Thus, there may possibly be a case in which the performance of the FPGA is not fully utilized depending on the mapping state of the PRM.

For example, as the conventional mapping rule of a PRM, the following rule is used. When PRMs are added, if PRRs the number of which is the same as that of PRMs to be added are present, the PRMs are arranged in ascending numerical order from among free PRRs. After the completion of a module process that uses the PRM that is arranged in a certain PRR, the PRM is immediately invalidated from the subject PRR and the subject PRR is set to be used. However, when using such a rule, the maximum operation frequency in the case where a PRM is arranged in each of the PRRs is not considered, it is difficult to improve the operation frequency of each of functional modules in an FPGA, and it is difficult to improve the performance of an information processing apparatus on which the FPGA is mounted.

On this point, even when using the conventional technology that sets the operation mode in accordance with the operating state of the basic logic cell circuit, it is difficult to improve the operation frequency of each of the functional modules in the FPGA and it is difficult to improve the performance of the information processing apparatus on which the FPGA is mounted. Furthermore, even when using the conventional technology that sets the operating characteristic of a transistor for each partial circuit of the circuit configuration circuit or the circuit wiring circuit, it is difficult to improve the operation frequency of each of the functional modules in the FPGA and it is difficult to improve the performance of the information processing apparatus on which the FPGA is mounted.

### SUMMARY

According to an aspect of an embodiment, an information processing apparatus includes: a plurality of partial reconfigurable regions that performs processes by using, from among a plurality of functional modules, the functional module that is arranged in each of the partial reconfigurable regions, respectively; an arrangement decision unit that decides the arrangement of the functional module into each of the partial reconfigurable regions on the basis of the maximum operation frequency for each of the partial reconfigurable regions in a case where each of the functional modules is arranged in the partial reconfigurable regions; and an arrangement processing unit that arranges the functional modules in the partial reconfigurable regions on the basis of the arrangement decided by the arrangement decision unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a server;

FIG. 2 is a block diagram illustrating the internal configuration of an FPGA;

FIG. 3 is a block diagram illustrating, in detail, a configuration control unit;

FIG. 4 is a schematic diagram illustrating an example of a maximum operation frequency information table;

FIG. 5 is a timing chart illustrating a process performed by partial reconfigurable modules;

FIG. 6 is a flowchart illustrating an arrangement process of the partial reconfigurable modules;

FIG. 7 is a flowchart illustrating a process of setting an initial selection candidate;

FIG. 8 is a flowchart illustrating a selection completion process of a target module;

FIG. 9 is a flowchart illustrating a candidate update process;

FIG. 10 is a flowchart illustrating an arrangement decision process of partial reconfigurable modules according to a second embodiment;

FIG. 11 is a flowchart illustrating a calculation process of reconfiguration hiding processing time;

FIG. 12 is a flowchart illustrating a calculation process of reconfiguration unhiding processing time;

FIG. 13 is a flowchart illustrating a process of setting an initial selection candidate when reconfiguration time is hidden;

FIG. 14 is a timing chart for explaining the effect of a process performed by the partial reconfigurable module according to the second embodiment;

FIG. 15 is a schematic diagram illustrating processing time for each arrangement of a second process and a third process;

FIG. 16 is a flowchart illustrating an arrangement decision process of partial reconfigurable modules according to a third embodiment;

FIG. 17 is a flowchart illustrating a calculation process of the second process priority hiding processing time;

FIG. 18 is a flowchart illustrating a calculation process of the third process priority hiding processing time; and

FIG. 19 is a flowchart illustrating a calculation process of the second process unhiding processing time.

### DESCRIPTION OF EMBODIMENTS

Preferred embodiments of the present invention will be explained with reference to accompanying drawings. Furthermore, the information processing apparatus, the information processing system, the information processing program, and the information processing method disclosed in the present invention are not limited to the embodiments described below.

### [a] First Embodiment

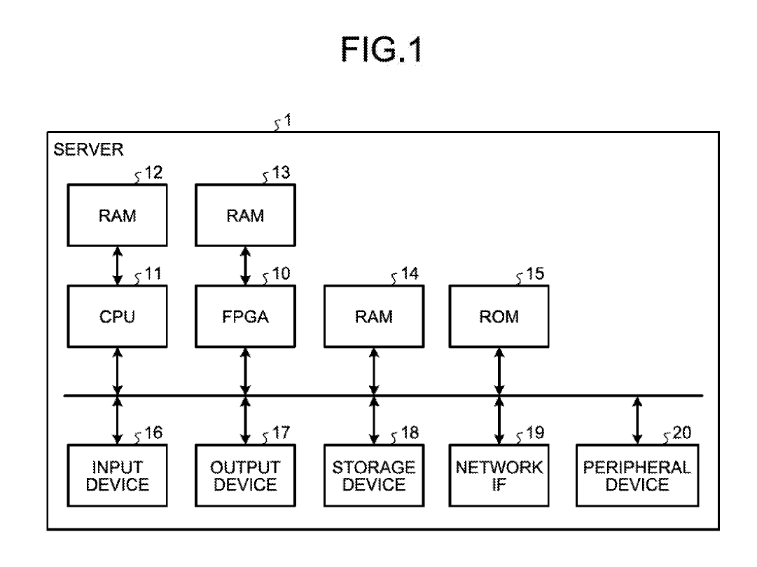

FIG. 1 is a block diagram illustrating a server. A server 1 corresponds to an example of an “information processing system”. The server 1 includes, as illustrated in FIG. 1, an FPGA 10, a CPU 11, random access memories (RAMS) 12 to 14, and a read only memory (ROM) 15. Furthermore, the server 1 includes an input device 16, an output device 17, a storage device 18, a network IF 19, and a peripheral device 20.

The RAM 14 and the ROM 15 are the main storage devices. The RAM 14 is, for example, a dynamic random access memory (DRAM). The ROM 15 is, for example, a flash memory.

The CPU 11 is connected to the RAM 12. The RAM 12 is a cache memory. Furthermore, the CPU 11 is connected, via a bus, to the FPGA 10, the RAM 14, the ROM 15, the input device 16, the output device 17, the storage device 18, the network IF 19, and the peripheral device 20. The CPU 11 uses the RAM 12, the RAM 14, the ROM 15, and the like, and performs arithmetic processing in cooperation with the FPGA 10. The CPU 11 corresponds to an example of an “arithmetic processing unit”.

Furthermore, the CPU 11 receives, from the input device 16 that is operated by an operator, an instruction to create a partial reconfigurable module (PRM). In response to the instruction received from the operator, the CPU 11 acquires configuration data on each of the partial reconfigurable modules. Furthermore, when the CPU 11 acquires the configuration data, the CPU 11 also acquires the maximum operation frequency that is created by previously operating each of the partial reconfigurable modules in a simulation program or the like and that is used in the case where each of the partial reconfigurable modules is arranged in each of the partial reconfigurable regions included in the FPGA 10. Then, the CPU 11 outputs, to the FPGA 10, the configuration data on the partial reconfigurable module to be used and information on the maximum operation frequency used in the case where each of the partial reconfigurable modules is arranged for each partial reconfigurable region.

The FPGA 10 is reconfigured so as to have a predetermined function in accordance with the instruction from the CPU 11. The FPGA 10 is connected to a RAM 13. The RAM 13 is a memory that can be used by the FPGA 10. Furthermore, the FPGA 10 is connected, via the bus, to the CPU 11, the RAM 14, the ROM 15, the input device 16, the output device 17, the storage device 18, the network IF 19, and the peripheral device 20. The FPGA 10 performs, by using the RAM 13, the RAM 14, the ROM 15, and the like, the function installed due to the reconfiguration and performs arithmetic processing in cooperation with the CPU 11. The reconfiguration function of the FPGA 10 will be described in detail later.

In response to an instruction received from the operator, the input device 16 inputs the information to the CPU 11 and the FPGA 10. The input device 16 is, for example, a keyboard, a mouse, or the like.

In response to an instruction received from the CPU 11 or the like, the output device 17 outputs the instructed information. The output device 17 is, for example, a monitor, a printer, or the like.

The storage device 18 is an auxiliary storage device. The storage device 18 is, for example, a hard disk.

The network interface (IF) 19 is an interface for connecting the CPU 11, the FPGA 10, or the like to an external network. The CPU 11 or the FPGA 10 performs communication with an external device via the network IF 19.

The peripheral device 20 is, for example, a compact disc read only memory (CD-ROM), a digital versatile disc (DVD), a universal system bus (USB) memory, an external hard disk, or the like.

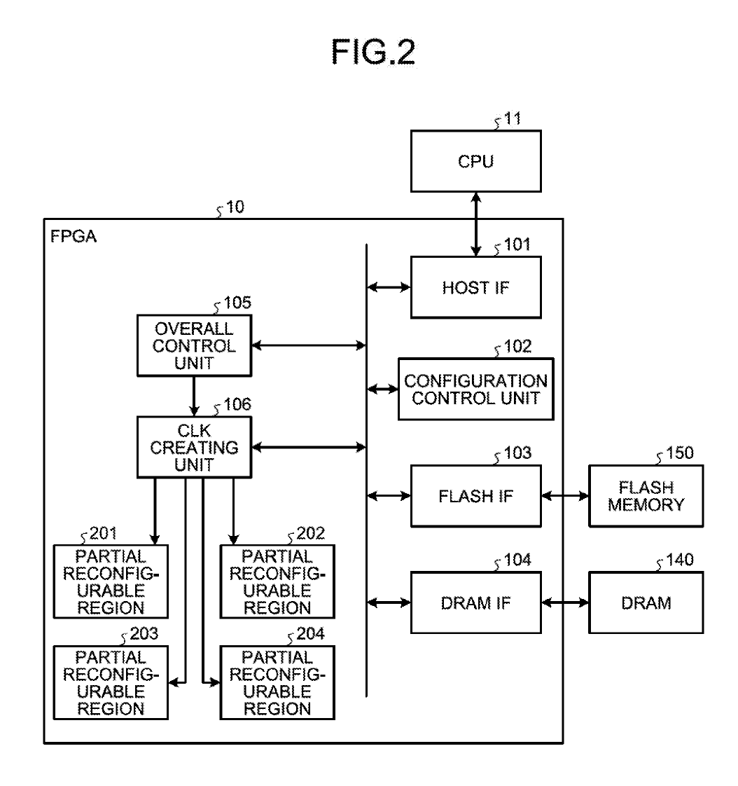

FIG. 2 is a block diagram illustrating the internal configuration of an FPGA. The FPGA 10 includes, as illustrated in FIG. 2, a host IF 101, a configuration control unit 102, a flash IF 103, a DRAM IF 104, an overall control unit 105, a clock (CLK) creating unit 106, and partial reconfigurable regions 201 to 204. In FIG. 2, the four partial reconfigurable regions 201 to 204 are illustrated; however, these are an example and the number of the partial reconfigurable regions is not particularly limited. In a description below, if the partial reconfigurable regions 201 to 204 are not distinguished, the partial reconfigurable regions 201 to 204 are referred to as a “partial reconfigurable region 200”.

The host IF 101, the configuration control unit 102, the flash IF 103, the DRAM IF 104, the overall control unit 105, and the CLK creating unit 106 are arranged in the fixed region in the FPGA. Namely, the host IF 101, the configuration control unit 102, the flash IF 103, the DRAM IF 104, the overall control unit 105, and the CLK creating unit 106 are not changed.

A flash memory 150 is connected to the flash IF 103 in the FPGA 10. The flash memory 150 corresponds to, for example, the ROM 15 illustrated in FIG. 1. The flash memory 150 stores therein configuration data on the partial reconfigurable modules.

Furthermore, a DRAM 140 is connected to the DRAM IF 104 in the FPGA 10. The DRAM 140 corresponds to, for example, the RAM 14 illustrated in FIG. 1. The DRAM 140 stores therein the maximum operation frequency information table that stores therein each of the maximum operation frequencies in the case where the partial reconfigurable modules created from the configuration data stored in the flash memory 150 are arranged in each of the partial reconfigurable regions 201 to 204. Namely, in the maximum operation frequency information table, the maximum operation frequency is registered with respect to a combination of the partial reconfigurable module and the partial reconfigurable region 200.

The host IF 101 is an interface for the configuration control unit 102 or the like connecting to a bus that is connected to the CPU 11, or the like. The flash IF 103 is an interface for the configuration control unit 102 or the like connecting to the flash memory 150. The DRAM IF 104 is an interface for the configuration control unit 102 connecting to the DRAM 140.

The overall control unit 105 is connected, via the bus, to the configuration control unit 102, the flash IF 103, the DRAM IF 104, the clock (CLK) creating unit 106, and the partial reconfigurable regions 201 to 204. The overall control unit 105 controls the overall operation of the FPGA 10. For example, the overall control unit 105 instructs the CLK creating unit 106 to create a clock and controls the timing of the operation of each of the units.

The CLK creating unit 106 outputs the clock to the host IF 101, the configuration control unit 102, the flash IF 103, the DRAM IF 104, the overall control unit 105, and the partial reconfigurable regions 201 to 204. In FIG. 2, the CLK creating unit 106 is illustrated so as to be connected to the partial reconfigurable regions 201 to 204; however, in practice, the CLK creating unit 106 is also connected to other units by the paths that supply the clock. In response to the control received from the overall control unit 105, the CKL creating unit 106 creates the clock that is output to each of the units.

The partial reconfigurable region 200 is a PRR. Although not illustrated in FIG. 2, the partial reconfigurable region 200 has a path that is used by the CPU 11, the RAM 14, the ROM 15, and the like to connect to the bus. Furthermore, the partial reconfigurable region 200 has a path for connecting to the RAM 13.

In response to the control received from the configuration control unit 102, a partial reconfigurable module (PRM) is arranged in the partial reconfigurable region 200. Then, a partial reconfigurable region 202 becomes a circuit that has the function performed by the arranged partial reconfigurable modules. Namely, the partial reconfigurable region 202 performs a process by using the arranged partial reconfigurable modules with respect to an input signal.

Furthermore, in response to the control received from the configuration control unit 102, in the partial reconfigurable region 200, the arranged partial reconfigurable modules are invalidated. Then, in the partial reconfigurable region 200, if the arranged partial reconfigurable modules are invalidated, partial reconfigurable modules can be arranged again.

The configuration control unit 102 decides which partial reconfigurable module is arranged in which the partial reconfigurable region 200 and arranges the partial reconfigurable module in the partial reconfigurable region 200 in accordance with the decision. Then, if the process performed by using the partial reconfigurable module arranged in the partial reconfigurable region 200 has been completed, the configuration control unit 102 invalidates the partial reconfigurable modules arranged in the partial reconfigurable region 200 in which the process has been completed. In a description below, the process performed by the partial reconfigurable modules that is arranged in the partial reconfigurable region 200 is referred to as a “module process”. In the following, arrangement of the partial reconfigurable modules performed by the configuration control unit 102 with respect to the partial reconfigurable region 200 will be described in detail.

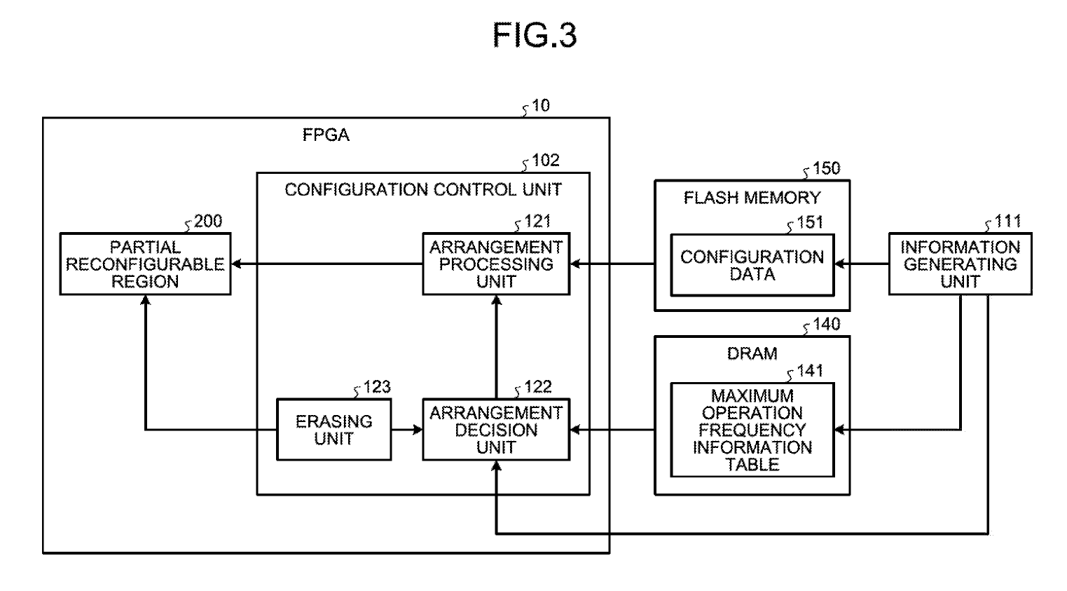

FIG. 3 is a block diagram illustrating, in detail, a configuration control unit. Here, in order to describe the configuration control unit 102 in detail, in the FPGA 10 illustrated in FIG. 3, the other functioning units, such as the overall control unit 105, or the like, are not illustrated.

An information generating unit 111 is implemented by, for example, a computer program in the server 1 being executed in the CPU 11. The information generating unit 111 previously creates configuration data 151 and a maximum operation frequency information table 141. Then, the information generating unit 111 stores the configuration data 151 in the flash memory 150. Furthermore, the information generating unit 111 stores the maximum operation frequency information table 141 in the DRAM 140.

Furthermore, the process performed by the server 1 includes one or a plurality of processing stages. In the following, the process including one or a plurality of processing stages is referred to as a “series of processes”. In order to allow the server 1 to perform a series of processes, the information generating unit 111 calculates the number of partial reconfigurable modules to be used by deciding which one of the partial reconfigurable modules is used which one of the processing stages and sets the calculated information in an arrangement decision unit 122.

The flash memory 150 holds the configuration data 151. Furthermore, the DRAM 140 holds the maximum operation frequency information table 141.

The arrangement decision unit 122 receives, from the information generating unit 111, an input of the type and the number of the partial reconfigurable modules that are used in each of the processing stages. Here, the type of the partial reconfigurable modules is, for example, identification information on the partial reconfigurable modules and the arrangement decision unit 122 can specify, from the type of the partial reconfigurable modules, which data is used from among the pieces of the configuration data 151. In a description below, the process in the stage subsequent to the process that is currently being performed is sometimes referred to as a “second process” and the process at the stage subsequent to the second process is sometimes referred to as a “third process”. Furthermore, in a description below, the maximum operation frequency in the partial reconfigurable region 200 in which a partial operation module that executes a certain process is arranged is sometimes referred to as the “maximum operation frequency of the subject process”.

The arrangement decision unit 122 sequentially decides, for each stage, the arrangement destination of the partial reconfigurable modules that are used for the process of the stage. Namely, at a certain stage, the arrangement decision unit 122 acquires, for each processing stage, the type and the number of partial reconfigurable modules to be used. Then, the arrangement decision unit 122 acquires, from the maximum operation frequency information table 14, the information on the maximum operation frequency for each of the partial reconfigurable regions 200 used by the partial reconfigurable modules that are used in the process at the subject stage. Then, the arrangement decision unit 122 decides the partial reconfigurable module to be arranged in each of the partial reconfigurable regions 200 such that the maximum operation frequency in the process at the subject stage is the highest, i.e., the lowest value of the maximum operation frequency at the subject stage is as high as possible. The arrangement decision unit 122 repeats the decision of the arrangement of the partial reconfigurable module for each stage of the process. In the following, a description will be given of an example of a decision process of arrangement of the partial reconfigurable modules performed by the arrangement decision unit 122 according to the embodiment.

Here, the number of types of the partial reconfigurable module is represented by M. Furthermore, each of the partial reconfigurable modules is represented by i (0≦i<M). The symbol “i” corresponds to the ID of the partial reconfigurable module. Here, the partial reconfigurable module represented by “i” is sometimes referred to as a “module i”. Furthermore, the number of use counts of each of the modules i is represented by Ni. Furthermore, the number of the partial reconfigurable regions 200 is represented by L. Furthermore, the partial reconfigurable region 200 is represented by j (0≦j<L). The symbol “j” corresponds to the ID of the partial reconfigurable region. In the following, the partial reconfigurable region 200 represented by j is sometimes referred to as a “region j”. Furthermore, the maximum operation frequency in a case in which the module i is arranged in the region j is represented by Fmax (i,j).

Then, the arrangement decision unit 122 sequentially extracts, in the order the maximum operation frequency is high, the partial reconfigurable modules that are included in the partial reconfigurable region 200 and the number of which is obtained by adding 1 to the number of partial reconfigurable modules that are to be used. Namely, the arrangement decision unit 122 acquires, regarding the module i, Ni+1 Fmax (i,j) in the order the value is high. Hereinafter, Ni+1 regions j associated with the acquired Fmax (i,j) is referred to as a “selection candidate” for the arrangement destination PRR with respect to the module i. In this way, the arrangement decision unit 122 performs the setting of the initial selection candidate with respect to each of the partial reconfigurable modules.

Furthermore, the arrangement decision unit 122 decides the state with respect to each of the partial reconfigurable modules in the partial reconfigurable regions 200. Here, the state of the region j with respect to the module i is represented by State (i,j). The state of the region j regarding the module i has four states, i.e., a selection candidate state, an invalid state, an unselected candidate state, and a selected state. The selection candidate state indicates that the region j has been selected as a candidate for the arrangement destination PRR of the module i. Here, the value indicating the selection candidate state is represented by “CAND (candidate)”. The invalid state indicates that the region j is not selected as the arrangement destination PRR of the module i. Here, the value indicating the invalid state is represented by “INVALID”. The unselected candidate state indicates that the state of the region j is not determined for the module i from among the selection candidate state, the invalid state, and the selected state. Here, the value indicating the unselected candidate state is represented by “NON_ACTIVE”. The selected state indicates that the region j has been determined as the arrangement destination PRR of a certain partial reconfigurable module. Here, the value indicating the selected state is represented by “SET”. Here, the arrangement decision unit 122 sets the state with respect to each of the partial reconfigurable modules regarding each of the initial selection candidates of the partial reconfigurable modules to CAND. Furthermore, the arrangement decision unit 122 sets, to NON_ACTIVE, the state with respect to the partial reconfigurable modules regarding the partial reconfigurable regions 200 that are other than the partial reconfigurable modules that are set to CAND.

Then, the arrangement decision unit 122 sets, to the lowest maximum operation frequency, the smallest maximum operation frequency from among the maximum operation frequency in each of the regions j of all of the modules i to be used, i.e., Fmax (i,j) having the lowest value. Furthermore, the arrangement decision unit 122 selects the partial reconfigurable module having the lowest maximum operation frequency as the target module that is targeted for selecting the arrangement destination PRR. Here, the target module is represented by module i_min, where the ID of the target module is represented by i_min.

Then, the arrangement decision unit 122 selects the greatest maximum operation frequency in the case where the target module (module i_min) is arranged in each of the initial selection candidates. Namely, the arrangement decision unit 122 selects the maximum value from the Fmax (i_min,j) that is the maximum operation frequency in the case where the target module is arranged for the initial selection candidate. Then, the arrangement decision unit 122 selects the selected partial reconfigurable region 200 having the greatest maximum operation frequency as the arrangement destination PRR of the target module. Here, the ID of the partial reconfigurable region 200 selected as the arrangement destination PPR is represented by j_max. Namely, the partial reconfigurable region 200 selected as the arrangement destination PPR of the target module is represented by region j_max. Furthermore, the arrangement decision unit 122 sets the state of the partial reconfigurable region 200 that has been selected as the arrangement destination PRR of the target module to the selected state. Namely, the arrangement decision unit 122 sets the subject state to be State (i_min,j_max)=SET.

Here, the arrangement decision unit 122 determines whether the partial reconfigurable regions 200 that have been selected as the arrangement destination PRR with respect to the target modules (module i_min) become the number of use counts (Ni_min). If the partial reconfigurable regions 200 that have been selected as the arrangement destination PRR with respect to the target modules (module i_min) become the number of use counts (Ni_min), the arrangement decision unit 122 performs the following process. Namely, the arrangement decision unit 122 sets all of the states with respect to the target modules in the partial reconfigurable regions 200 other than the partial reconfigurable regions 200 that have been selected as the arrangement destination PRR to invalid. For example, if the partial reconfigurable region other than the partial reconfigurable regions 200 that have been selected as the arrangement destination PRR is represented by region ej (ej≠j_max), the arrangement decision unit 122 sets the subject state to State (i_min,ej)=INVALID. Namely, the arrangement decision unit 122 performs a selection completion process that decides the state with respect to the target modules in all of the partial reconfigurable regions 200. Then, the arrangement decision unit 122 performs an update process of the selection candidate.

In contrast, if the partial reconfigurable regions 200 that have been set to the selection candidates with respect to the target modules (module i_min) do not reach the number of use counts (Ni_min), the arrangement decision unit 122 performs an update process on the selection candidates without performing the selection completion process on the target modules.

The arrangement decision unit 122 performs the update process on the selection candidates as follows. The arrangement decision unit 122 sequentially selects the partial reconfigurable modules other than the target modules. Then, the arrangement decision unit 122 determines whether the partial reconfigurable regions 200 that have been selected as the arrangement destination PRR of the target modules are the selection candidates for the selected partial reconfigurable modules. If the subject regions are the selection candidates, the arrangement decision unit 122 changes, to the selection candidate from among the partial reconfigurable regions 200 in which the state with respect to the selected partial reconfigurable modules are in the invalid state, the partial reconfigurable region 200 that have the maximum operation frequency in the case where the selected partial reconfigurable modules are arranged. Namely, if the selected partial reconfigurable module is represented by module si and the partial reconfigurable region 200 with the maximum operation frequency in the case where the module si is arranged is represented by sj, the arrangement decision unit 122 changes the value of State (si,sj) from NON_ACTIVE to CAND.

If the region is not the selection candidate or after the other partial reconfigurable region 200 is added to the selection candidate, the arrangement decision unit 122 sets the state with respect to the selected partial reconfigurable module of the partial reconfigurable region 200 that has been selected as the arrangement destination PRR of the target module to the invalid state. Namely, if the selected partial reconfigurable module is represented by the module si, the arrangement decision unit 122 sets the subject state to State (si,j_max)=INVALID. In this way, the arrangement decision unit 122 updates the selection candidates of the partial reconfigurable modules other than the target modules.

Then, the arrangement decision unit 122 repeats the process described above until the arrangement decision unit 122 decides the arrangement destination PRRs the number of which corresponds to the number of arrangements and that is with respect to all of the partial reconfigurable modules to be used. Consequently, the arrangement decision unit 122 decides the arrangement destination PRRs of all of the partial reconfigurable modules to be used.

Then, the arrangement decision unit 122 notifies an arrangement processing unit 121 of information on the arrangement of the decided partial reconfigurable modules into the partial reconfigurable regions 200. Furthermore, the arrangement decision unit 122 receives a notification from an erasing unit 123 indicating that the reconfiguration is available in the partial reconfigurable regions 200 in each of which the partial reconfigurable modules have been arranged. Then, the arrangement decision unit 122 decides the arrangement of the partial reconfigurable modules in the second processing stage after adding the notified partial reconfigurable region 200 to the partial reconfigurable region 200 that can be selected as the arrangement destination of the partial reconfigurable module in the second processing stage. Namely, in the embodiment, the arrangement decision unit 122 decides the arrangement of the partial reconfigurable modules in the second processing stage after the end of the process of the previous processing stage and after the partial reconfigurable modules used in the previous process have been invalid.

The arrangement processing unit 121 receives, from the arrangement decision unit 122, the arrangement information on the partial reconfigurable regions 200 of the partial reconfigurable modules to be used. Then, the arrangement processing unit 121 acquires, from the flash memory 150, the configuration data 151 on the partial reconfigurable modules specified by the arrangement information. Then, the arrangement processing unit 121 creates information on the specified partial reconfigurable regions 200 of the arrangement destination and a bit stream addressed to the partial reconfigurable regions 200 specified by the configuration data 151. Then, the arrangement processing unit 121 outputs the created bit stream to the partial reconfigurable regions 200 of the arrangement destination and arranges the specified partial reconfigurable modules into the partial reconfigurable regions 200 at the arrangement destination.

The erasing unit 123 acquires the state of the operation of the partial reconfigurable regions 200; invalidates, if a module process performed by the partial reconfigurable module arranged in the certain partial reconfigurable region 200 has been completed, the partial reconfigurable module arranged in the certain partial reconfigurable region 200; and allows the certain partial reconfigurable region 200 to be reconfigured. Then, the erasing unit 123 outputs, to the arrangement decision unit 122, the information on the partial reconfigurable region 200 in which reconfiguration can be performed.

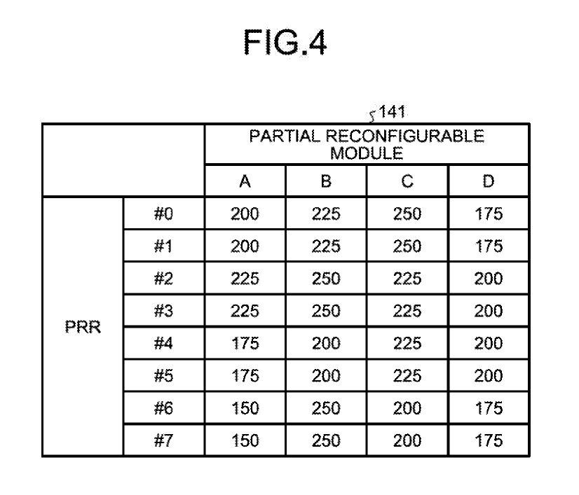

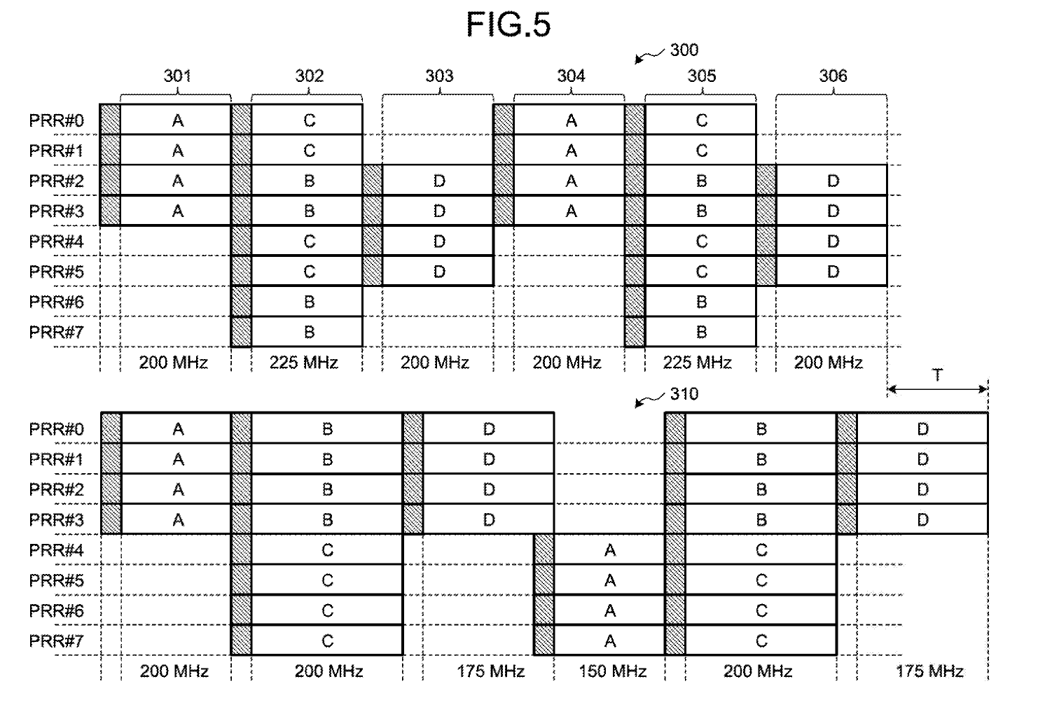

Here, arrangement of the partial reconfigurable modules to the partial reconfigurable regions 200 performed by the arrangement decision unit 122 in each stage of the series of the processes will be specifically described with reference to FIGS. 4 and 5. FIG. 4 is a schematic diagram illustrating an example of a maximum operation frequency information table. FIG. 5 is a timing chart illustrating a process performed by a partial reconfigurable module. Here, a description will be given in a case of using eight partial reconfigurable regions #0 to #7 of the partial reconfigurable regions 200 and four partial reconfigurable modules of the partial reconfigurable modules A to D. Here, a description will be given in a case in which the series of processes performs a process using a partial reconfigurable module A in a first stage, performs a process using partial reconfigurable modules B and C in a second stage, and performs a process using a partial reconfigurable module D in a third stage, and, furthermore, each of the processes are repeated twice. Furthermore, a description will be given of a case in which, in the process in each stage, each of the partial reconfigurable modules A to D uses four partial reconfigurable regions 200.

First, in the first stage, process is performed in the state in which the partial reconfigurable modules A are arranged in the four partial reconfigurable regions 200. Thus, the arrangement decision unit 122 decides the arrangement of the partial reconfigurable modules A such that the lowest value of the maximum operation frequency becomes the highest when the partial reconfigurable modules A are arranged in the partial reconfigurable regions #0 to #7. Specifically, the arrangement decision unit 122 decides to arrange the partial reconfigurable modules A into the partial reconfigurable regions 200 that are associated with the top four maximum operation frequencies. A case of arranging the partial reconfigurable modules A are arranged on the basis of the sate illustrated in FIG. 4 in the partial reconfigurable regions #0 to #3 corresponds to the arrangement of the top four maximum operation frequencies. Thus, the arrangement decision unit 122 decides to arrange the partial reconfigurable module A into the partial reconfigurable regions #0 to #3.

A graph 300 illustrated in the upper portion of FIG. 5 is a graph when arrangement is performed such that the lowest value of the maximum operation frequency is the highest. By deciding the arrangement described above, the partial reconfigurable modules A are arranged indicated by period of time 301 illustrated in FIG. 5. The partial reconfigurable modules A perform the process of the first stage represented by the period of time 301. The oblique line portions illustrated in FIG. 5 is time elapsed due to erasure and arrangement of the partial reconfigurable modules. In a description below, erasure and the arrangement of the partial reconfigurable modules or the arrangement of the partial reconfigurable modules into the partial reconfigurable regions 200 in which the partial reconfigurable modules have not been arranged is sometimes referred to as “reconfiguration of the partial reconfigurable modules”. In FIG. 5, the symbol of each of the partial reconfigurable modules operated in the partial reconfigurable regions 200 is added to the position associated with each of the partial reconfigurable regions 200 in the stages. In the first stage, the partial reconfigurable modules A are operated at the maximum operation frequency of 200 MHz when arrangement is performed in the partial reconfigurable regions #0 and #1 indicated in the maximum operation frequency information table 141 illustrated in FIG. 4.

Furthermore, in the second stage, the process is performed in the state in which the partial reconfigurable modules B and C are arranged in the respective four partial reconfigurable regions 200. Thus, the arrangement decision unit 122 decides the arrangement of the partial reconfigurable modules B and C such that the lowest value of the maximum operation frequency becomes the highest when the partial reconfigurable modules B and C are arranged in the partial reconfigurable regions #0 to #7. Specifically, the arrangement decision unit 122 arranges the partial reconfigurable modules B in partial reconfigurable regions #2, #3, #6, and #7. Furthermore, the arrangement decision unit 122 arranges the partial reconfigurable modules C in partial reconfigurable regions #0, #1, #4, and #5. When arrangement is performed in this way, the partial reconfigurable modules B and C are operated at the maximum operation frequency of 225 MHz in the case where the partial reconfigurable modules C illustrated in FIG. 4 are arranged in the partial reconfigurable regions #4 and #5. Namely, the partial reconfigurable modules B and C are operated at the maximum operation frequency of 225 MHz in the second stage represented by a period of time 302.

In this case, in the period of time 302, the arrangement indicated by the graph 300 can be decided by selecting the partial reconfigurable modules in which the maximum operation frequency becomes higher in each of the partial reconfigurable regions #0 to #7. In contrast, in the combination of the partial reconfigurable modules B and C and the partial reconfigurable regions #0 to #7, if the arrangement is performed by combining the modules in the order the maximum operation frequency is high, it is conceivable that the maximum operation frequency of the partial reconfigurable modules B and C becomes the same in a certain partial reconfigurable region. In this case, the partial reconfigurable modules B and C are arranged in the partial reconfigurable regions other than the arranged partial reconfigurable regions in which the arrangement of the functional modules has been decided such that the type of the partial reconfigurable modules, in which the highest value of the maximum operation frequency is lower in the case where the partial reconfigurable modules B and C are arranged, is arranged in the subject partial reconfigurable region in which the subject maximum operation frequency matches.

For example, a description will be given of a case in which, in the state in which the partial reconfigurable modules C are decided to be arranged in the partial reconfigurable regions #0 and #1 and the partial reconfigurable modules B are decided to be arranged in the partial reconfigurable regions #2 and #3, the maximum operation frequency can be obtained when either the partial reconfigurable modules B or C is arranged in either the partial reconfigurable region #4 or #5. In this case, considering the maximum operation frequency in the case where the partial reconfigurable modules B and C are arranged in the partial reconfigurable regions #4 to #7 in each of which the arrangement is not decided. In this case, it is assumed that the lowest value of the maximum operation frequency in the case where the partial reconfigurable module C is arranged in each of the partial reconfigurable regions #4 to #7 is lower than the lowest value of the maximum operation frequency in the case where the partial reconfigurable module B is arranged in each of the partial reconfigurable regions #4 to #7. In this case, the partial reconfigurable module C is arranged in the partial reconfigurable regions #4 and #5.

Furthermore, in the third stage, a process is performed in the state in which the partial reconfigurable modules D are arranged in the four partial reconfigurable regions 200. Thus, the arrangement decision unit 122 decides the arrangement of the partial reconfigurable modules D such that, when the partial reconfigurable modules D are arranged in the partial reconfigurable regions #0 to #7, the lowest value of the maximum operation frequency becomes the highest. Specifically, the arrangement decision unit 122 arranges the partial reconfigurable modules D in the partial reconfigurable regions #2 to 5. In this case, the partial reconfigurable modules D are operated at the maximum operation frequency of 200 MHz when the partial reconfigurable modules D are arranged in the partial reconfigurable regions #2 to 5 illustrated in FIG. 4. Namely, the partial reconfigurable modules D are operated at the maximum operation frequency of 200 MHz in the third stage represented by the period of time 303. Then, in the fourth stage to the sixth stage, i.e., period of time 304 to 306, the same processes as those performed at the period of time 301 to 303 are performed.

In contrast, a graph 310 indicated in the lower portion illustrated in FIG. 5 is a graph when the partial reconfigurable modules are arranged in ascending numerical order of the free partial reconfigurable regions 200.

In this case, in the first stage, because all of the partial reconfigurable regions #0 to #7 are free, the partial reconfigurable modules A are arranged in the partial reconfigurable regions #0 to #3. Because this is the same arrangement as that performed such that the lowest value of the maximum operation frequency becomes the highest, the operation is performed at the same maximum operation frequency.

Then, in the second stage, because all the eight partial reconfigurable regions #0 to #7 are used, the erasure and the reconfiguration are waited. Then, the partial reconfigurable modules B and C are arranged in ascending numerical order of the partial reconfigurable regions #0 to #7. In this case, because the partial reconfigurable modules C are arranged in the partial reconfigurable regions #6 and #7, the partial reconfigurable modules B and C are, as illustrated in FIG. 4, operated at the maximum operation frequency of 200 MHz that is lower than that used when the arrangement is performed such that the lowest value of the maximum operation frequency becomes the highest.

Then, after the second stage, because no free space is present in the partial reconfigurable regions #0 to #7, the partial reconfigurable modules B and C are invalidated from the partial reconfigurable regions #0 to #7. Then, the partial reconfigurable modules D are arranged in ascending numerical order of the partial reconfigurable regions #0 to #3.

In the subsequent third stage, because the four regions of the partial reconfigurable regions #4 to #7 are free, before the end of the partial reconfigurable modules D, the partial reconfigurable modules A are arranged in the partial reconfigurable regions #4 to #7. Then, the end of the module process performed by the partial reconfigurable modules D, the module process performed by the partial reconfigurable modules A is immediately started. However, because the partial reconfigurable modules A are arranged in the partial reconfigurable regions #6 and #7, the operation is performed at the maximum operation frequency of 150 MHz as illustrated in FIG. 4.

Then, in the fifth stage and the sixth stage, the same arrangement as that performed in the second stage and the third stage and the processes of the partial reconfigurable modules B to D are performed.

In this case, in all of the stages after the second stage, in a case in which arrangement is performed such that the lowest value of the maximum operation frequency becomes the highest, the partial reconfigurable modules are operated at the maximum operation frequency that is higher than that in a case in which the partial reconfigurable modules are arranged in ascending numerical order of the free regions. Thus, in a case in which the arrangement is performed such that the lowest value of the maximum operation frequency is set to be the highest, the processing time is shortened by time T compared with the case in which the partial reconfigurable modules are arranged in ascending numerical order of the free partial reconfigurable regions 200.

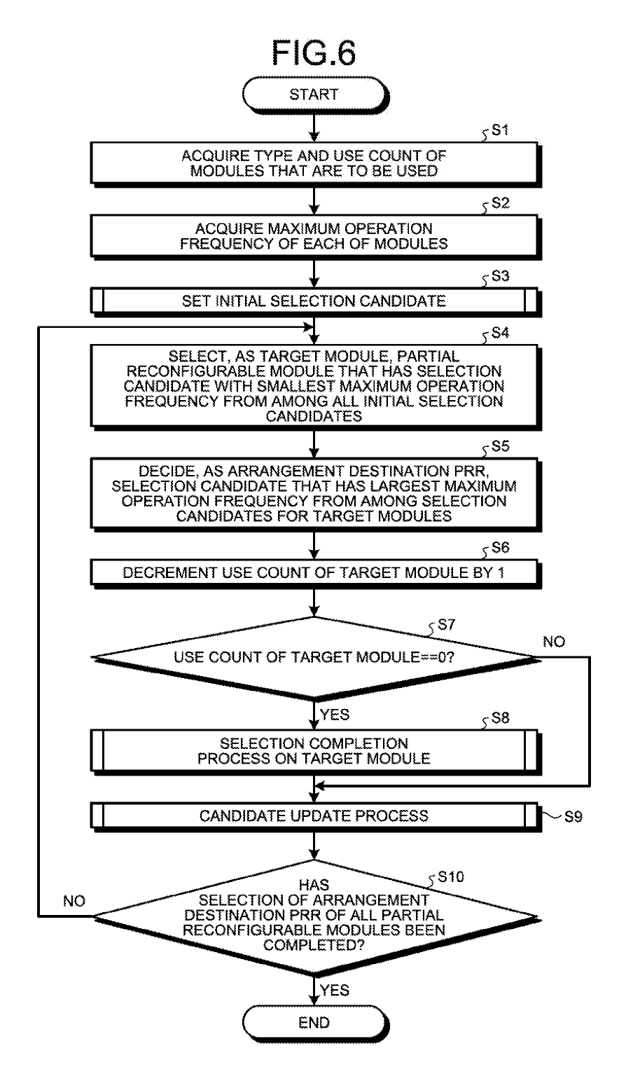

In the following, the flow of the arrangement process of the partial reconfigurable modules in the FPGA 10 according to the embodiment will be described with reference to FIG. 6. FIG. 6 is a flowchart illustrating an arrangement process of the partial reconfigurable module.

The arrangement decision unit 122 acquires the type and the number of use counts of the modules that are to be used and that are input from the input device 16 (Step S1). For example, the arrangement decision unit 122 M modules as the type of modules and acquires N1 to NM modules as the number of M modules i.

Then, the arrangement decision unit 122 acquires the maximum operation frequency of each of the modules (Step S2). For example, the arrangement decision unit 122 acquires Fmax (i,j) (0≦i≦M, 0≦j≦M).

Then, the arrangement decision unit 122 performs the setting of the initial selection candidates (Step S3). Regarding the setting of the initial selection candidates in detail will be described later. Then, the arrangement decision unit 122 sets the state of the initial setting candidate with respect to each of the modules to the selection candidate (CAND) and sets the state other than this state to the unselected candidates (NON_ACTIVE).

Then, from among the initial selection candidates in each of which the state has not been decided, the arrangement decision unit 122 specifies the initial selection candidate in which the maximum operation frequency is the smallest. Then, the arrangement decision unit 122 selects, as the target module, the partial reconfigurable module (module i_min) that has the specified selection candidate (Step S4).

Then, the arrangement decision unit 122 decides the selection candidate (region j_max) that has the greatest maximum operation frequency from among the selection candidates for the target modules as the arrangement destination PRR of the target module (Step S5). Namely, the arrangement decision unit 122 sets the subject state to State (i_min,j_max)=SET.

Then, the arrangement decision unit 122 decrements the number of use counts of the target modules by 1 (Step S6). Namely, if the number of use counts of the target modules at that time point is set to Ni_min, the arrangement decision unit 122 sets the subject state to Ni_min=Ni_min−1.

Then, the arrangement decision unit 122 determines whether the number of use counts of the target modules is 0 (Step S7). If the number of use counts of the target modules is not 0 (No at Step S7), the arrangement decision unit 122 proceeds to Step S9.

In contrast, if the number of use counts of the target modules is 0 (Yes at Step S7), the arrangement decision unit 122 performs the selection completion process on the target modules (Step S8). Here, in FIG. 6, the equal sign is represented by “==”. The flow of the selection completion process of the target modules will be described in detail later. Consequently, the arrangement decision unit 122 decides the state of all of the partial reconfigurable regions 200 with respect to the target modules.

Then, the arrangement decision unit 122 performs the candidate update process and updates the selection candidates of the partial reconfigurable modules other than the target modules (Step S9). The flow of the candidate update process will be described in detail later.

Then, the arrangement decision unit 122 determines whether the selection of the arrangement destination PRR of all of the partial reconfigurable modules has been completed (Step S10). If there is the partial reconfigurable module whose arrangement destination PRR needs to be selected (No at Step S10), the arrangement decision unit 122 returns to Step S4.

In contrast, if there is no partial reconfigurable module whose arrangement destination PRR does not need to be selected (Yes at Step S10), the arrangement decision unit 122 ends the arrangement process of the partial reconfigurable modules to the partial reconfigurable regions 200.

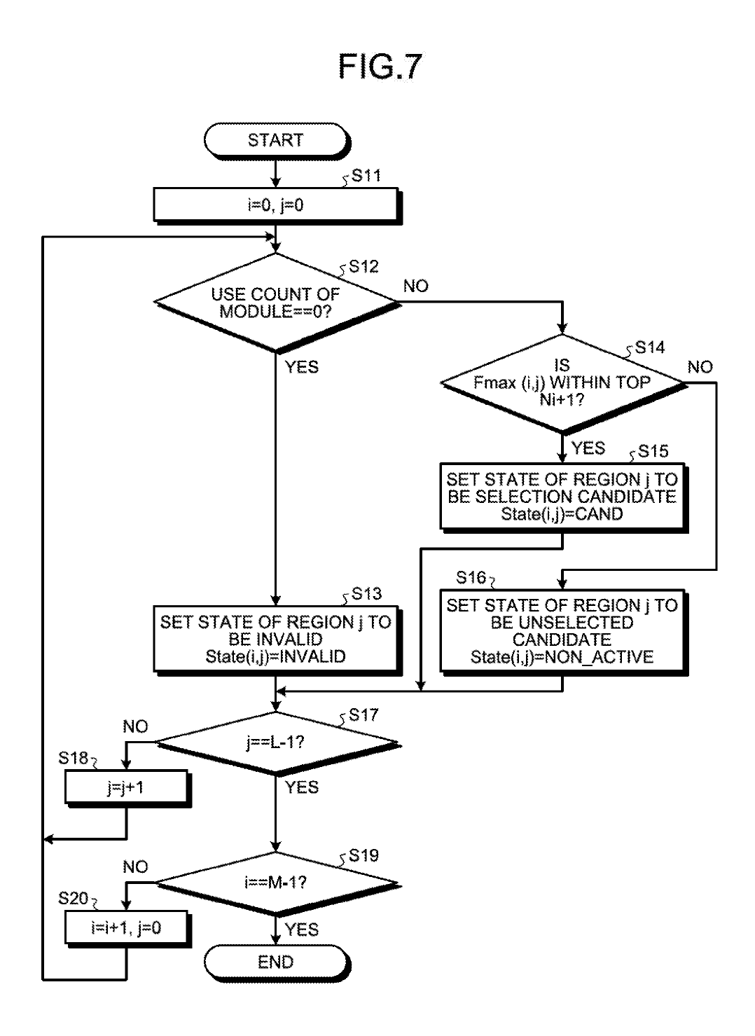

In the following, the flow of the process of setting the initial selection candidate will be described with reference to FIG. 7. FIG. 7 is a flowchart illustrating a process of setting an initial selection candidate. The process indicated by the flowchart illustrated in FIG. 7 corresponds to the process performed at Step S3 illustrated in FIG. 6. Here, a description will be given with the assumption that the number of unused partial reconfigurable modules is zero. Here, in a description below, “=” represents substitution and “==” represents an equal sign.

The module ID of the partial reconfigurable module is represented by i and the subject partial reconfigurable module is represented by module i. The region ID of the partial reconfigurable region 200 is represented by j and the subject partial reconfigurable region 200 is represented by PRRj. The maximum operation frequency of the module i in PRRj is represented by Fmax (i,j). Here, the arrangement decision unit 122 sets, to the region j, the available partial reconfigurable region 200 that is in the state in which the partial reconfigurable module that performs the series of processes is not arranged.

Then, the arrangement decision unit 122 sets the state to i=0 and j=0 (Step S11).

The arrangement decision unit 122 determines whether the number of use counts of the modules Ni is zero, i.e., determines whether the module i is to be used in the second process (Step S12). If the number of use counts of the module Ni is zero (Yes at Step S12), the arrangement decision unit 122 sets the state of the module i in the region j to be invalid. Namely, the arrangement decision unit 122 sets the subject state to State (i,j)=INVALID (Step S13). Consequently, the state of all of the partial reconfigurable regions 200 with respect to the partial reconfigurable modules that are used for the series of the processes are set to be invalid.

In contrast, if the number of use counts of the modules Ni is not zero (No at Step S12), the arrangement decision unit 122 determines whether Fmax (i,j) is within the number of use counts of the module Ni+1 counted in descending numeric order (Step S14). If Fmax (i,j) is within the top Ni+1 (Yes at Step S14), the arrangement decision unit 122 decides the state of the module i in the region j to be a selection candidate. Namely, the arrangement decision unit 122 sets the subject state to State (i,j)=CAND (Step S15).

In contrast, if Fmax (i,j) is not within the top Ni+1 (No at Step S14), the arrangement decision unit 122 decides the state of the module i in the region j to be an unselected candidate. Namely, the arrangement decision unit 122 sets the subject state to State (i,j)=NON_ACTIVE (Step S16).

Then, the arrangement decision unit 122 determines, regarding all of the partial reconfigurable regions 200, whether the state of the module i has been decided. Namely, the arrangement decision unit 122 determines whether j==L−1 is satisfied (Step S17). If the partial reconfigurable region 200 in which the state of the module i has not been decided is present (No at Step S17), the arrangement decision unit 122 increments the value of j by 1 (j=j+1) (Step S18) and returns to Step S12.

In contrast, if the decision of the state of the module i regarding to all of the partial reconfigurable regions 200 has been completed (Yes at Step S17), the arrangement decision unit 122 determines, regarding all of the partial reconfigurable modules, whether a selection candidate has been specified. Namely, the arrangement decision unit 122 determines whether i==M−1 is satisfied (Step S19). If there is a partial reconfigurable module in which specification of a selection candidate has not been ended (No at Step S19), the arrangement decision unit 122 increments the value of i by 1 (i=i+1), sets the state to be j=0 (Step S20), and returns to Step S12.

In contrast, regarding all of the partial reconfigurable modules, if the specification of the selection candidate has been completed (Yes at Step S19), the arrangement decision unit 122 ends the process of setting the initial selection candidate. Consequently, the arrangement decision unit 122 can decides the state of all of the partial reconfigurable regions 200 with respect to all of the partial reconfigurable modules.

Here, in FIG. 7, the state of each of the partial reconfigurable regions 200 has also been decided with respect to unused partial reconfigurable modules; however, the arrangement decision unit 122 may also previously select the partial reconfigurable module to be used and then decide the state of each of the partial reconfigurable regions 200. In this case, it may also be possible to omit Steps S12 and 13, proceeds from Step S11 to Step S14, and sets the destination of the process after the process at Steps S18 and S20 to Step S14.

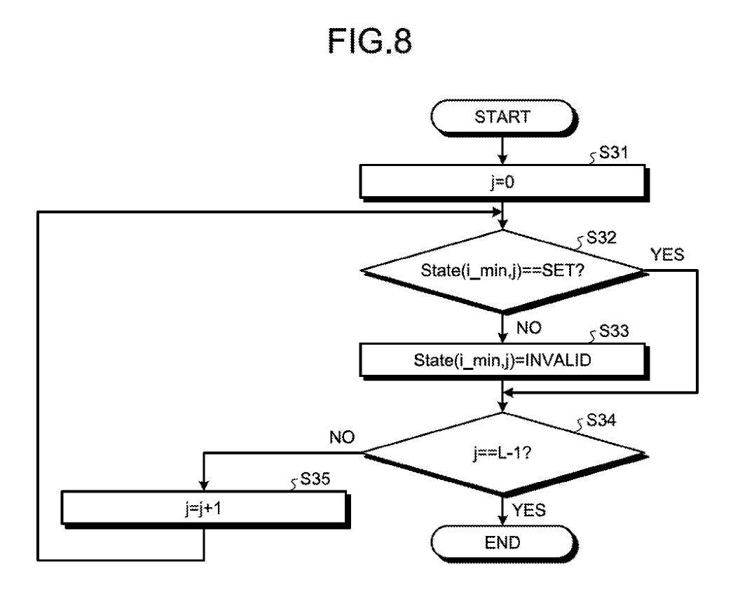

In the following, the flow of a selection completion process performed on the target module will be described with reference to FIG. 8. FIG. 8 is a flowchart illustrating a selection completion process performed on a target module. The process indicated by the flowchart illustrated in FIG. 8 corresponds to the process performed at Step S8 illustrated in FIG. 6. Here, a description will be given in a case in which the target module is represented by module i_min.

Here, the region ID of the partial reconfigurable region 200 is represented by j. The arrangement decision unit 122 sets j to be zero (j=0) that is the initial value (Step S31).

Then, the arrangement decision unit 122 determines whether the state of the region j with respect to the target module (module i_min) has been selected. Namely, the arrangement decision unit 122 determines whether State (i_min,j)==SET is satisfied (Step S32). If the state of the region j with respect to the target module has been selected (Yes at Step S32), the arrangement decision unit 122 proceeds to Step S34.

In contrast, if the state of the region j with respect to the target module has not been selected (No at Step S32), the arrangement decision unit 122 sets the state of the region j with respect to the target module to be invalid. Namely, the arrangement decision unit 122 sets the subject state to be State (i_min,j)=INVALID (Step S33).

Then, the arrangement decision unit 122 determines whether, regarding all of the partial reconfigurable regions 200, the decision of the state of the target modules have been performed. Namely, the arrangement decision unit 122 determines whether j==L−1 is satisfied (Step S34).

If there is the partial reconfigurable region 200 in which the state of the target module has not been decided (No at Step S34), the arrangement decision unit 122 increments the value of j by 1 (j=j+1) (Step S35) and returns to Step S32.

In contrast, if the arrangement decision unit 122 decides the state of the target module regarding all of the partial reconfigurable regions 200 (Yes at Step S34), the arrangement decision unit 122 ends the selection completion process on the target module.

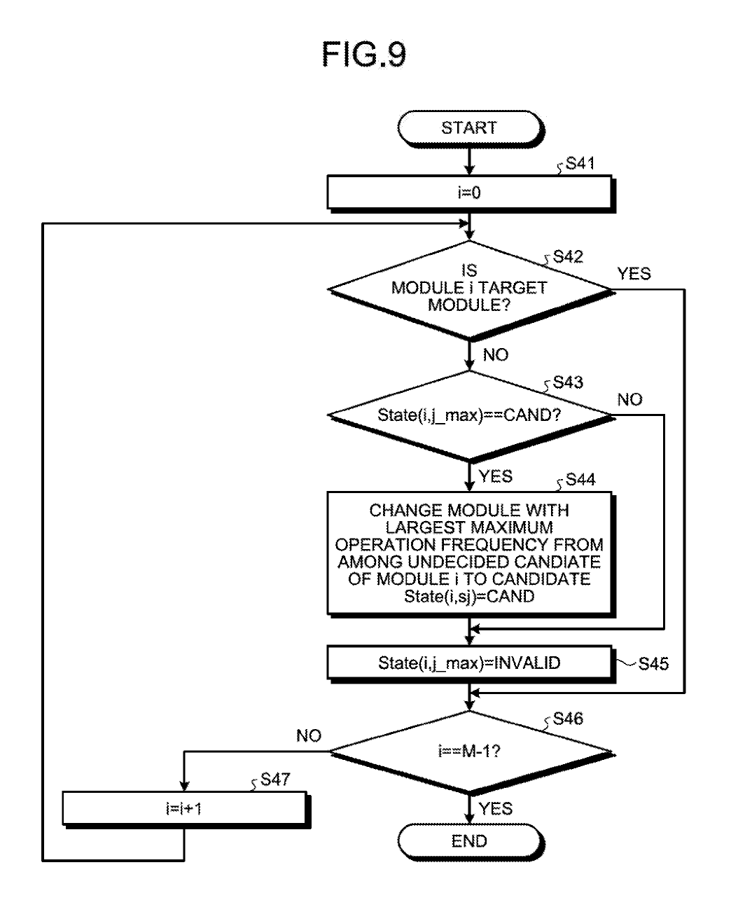

In the following, the flow of a candidate update process will be described with reference to FIG. 9. FIG. 9 is a flowchart illustrating a candidate update process. The processes indicated by the flowchart illustrated in FIG. 9 correspond to the process performed at Step S9 illustrated in FIG. 6. Here, a description will be given in a case in which the target module is represented by module i_min. Furthermore, a description will be given in a case in which the region j_max has been selected as the arrangement destination PRR of the target module.

Here, the module ID of the partial reconfigurable module is represented by i and the subject partial reconfigurable module is represented by the module i. The arrangement decision unit 122 sets the state to be i=0 (Step S41).

The arrangement decision unit 122 determines whether the module i is the target module (i=i_min) (Step S42). If the module i is the target module (Yes at Step S42), the arrangement decision unit 122 proceeds to Step S46.

In contrast, if the module i is not the target module (No at Step S42), the arrangement decision unit 122 determines whether the partial reconfigurable region 200 (region j_max) that has been selected as the arrangement destination PRR of the target module is the selection candidate of the module i. Namely, the arrangement decision unit 122 determines whether State (i,j_max)==CAND is satisfied (Step S43). If the region j_max is not the selection candidate of the module i (No at Step S43), the arrangement decision unit 122 proceeds to Step S45.

In contrast, if the region j_max is the selection candidate of the module i (Yes at Step S43), the arrangement decision unit 122 selects, from among the partial reconfigurable regions 200 that are undecided candidates for the module i, the partial reconfigurable region 200 with the largest maximum operation frequency in the case where the module i is arranged. Then, the arrangement decision unit 122 changes the state of the module i with respect to the selected partial reconfigurable region 200 to a selection candidate (Step S44). Namely, if the selected partial reconfigurable region 200 is represented by a region sj, the arrangement decision unit 122 changes State (i,sj)=NON_ACTIVE to State (i,sj)=CAND.

Then, the arrangement decision unit 122 sets the state of the module i with respect to the partial reconfigurable region 200 (region j_max), which is set to be the arrangement destination PRR of the target module, to be invalid. Namely, the arrangement decision unit 122 sets the state to be State (i,j_max)=INVALID (Step S45).

Thereafter, the arrangement decision unit 122 determines whether an update of the selection candidate with respect to all of the partial reconfigurable modules has been ended. Namely, the arrangement decision unit 122 determines whether i==M−1 is satisfied (Step S46).

If an update of the selection candidate has not been ended (No at Step S46), the arrangement decision unit 122 increments i by 1 (i=i+1) (Step S47) and returns to Step S42.

In contrast, if an update of the selection candidate with respect to all of the partial reconfigurable modules has been ended (Yes at Step S46), the arrangement decision unit 122 ends the candidate update process.

Here, in the flow illustrated in FIGS. 7 to 9, in order to easy to understand, a description has been given of a case in which the arrangement decision unit 122 decides each variable, gives the initial value, and then performs each of the processes; however, the arrangement decision unit 122 does not need to decide the variable or set the initial value. Namely, the arrangement decision unit 122 may also perform each of the processes by using the information on the partial reconfigurable modules or the partial reconfigurable regions 200 without changing anything.

As described above, when the FPGA according to the embodiment performs dynamic reconfiguration on the partial reconfigurable modules with respect to the partial reconfigurable regions, the FPGA arranges the partial reconfigurable modules such that the lowest value of the maximum operation frequency is the greatest. Consequently, each of the partial reconfigurable modules can be arranged in the partial reconfigurable regions in each of which a high frequency operation is possible. Thus, it is possible to operate each of the partial reconfigurable modules at a high frequency and thus it is possible to improve the performance.

Here, in the embodiment, a description has been given of a case in which the operation period of time does not overlap with other process for each processing stage; however, for example, if the first process can be performed in parallel with the second process, the second process can be performed without waiting for the end of the first process. In this case, the arrangement described above is performed by using, as the arrangement target of the partial reconfigurable module, the remaining partial reconfigurable regions 200 obtained by excluding the partial reconfigurable regions 200 in which the partial reconfigurable modules are arranged in the first process.

### [b] Second Embodiment

In the following, a second embodiment will be described. An FPGA according to the embodiment differs from the first embodiment in that, when performing the process in the next stage, the FPGA performs reconfiguration by deciding whether to perform reconfiguration by using the partial reconfigurable regions that are used by the process that is being performed or to perform reconfiguration, without using the subject partial reconfigurable regions, in parallel with the process that is being processed. Thus, in a description below, the function of deciding the arrangement of the partial reconfigurable modules will mainly be described. The server and the FPGA according to the embodiment are also indicated by FIGS. 1 to 3. In a description below, descriptions of units having the same functions as those performed in the first embodiment will be omitted.

In the following, a case of arranging the partial reconfigurable modules in parallel with the process that is being performed and performing the next stage process is referred to as a “case of hiding the reconfiguration time”. Furthermore, after the end of the arrangement of the partial reconfigurable modules by using the partial reconfigurable regions that were used by the process in execution, a case of performing the process in the next stage is referred to as a “case of not hiding the reconfiguration time”.

The arrangement decision unit 122 acquires the type and the number of partial reconfigurable modules that are used in the next process. Then, the arrangement decision unit 122 estimates reconfiguration time in the case where the partial reconfigurable module that is used in the next process is reconfigured and estimates execution time in the case where each of the partial reconfigurable modules is operated at a previously decided predetermined frequency. The reconfiguration time in the case where the partial reconfigurable module to be used in the next process is reconfigured includes therein the time period for which the partial reconfigurable module is invalidated from the partial reconfigurable regions 200 that are used in the previous stage.

Here, the reconfiguration time is generally increased in accordance with the size of a region that is used to arrange a partial reconfigurable module, i.e., an amount of configuration data that is rewritten. Consequently, if the system configuration and configuration data are decided, the reconfiguration time is almost decided. Thus, the reconfiguration time can be estimated from prior information. Namely, the arrangement decision unit 122 estimates the reconfiguration time from the prior information, such as the system configuration, the configuration data, or the like.

Furthermore, because the processing parameter, such as the number of loops, varies due to the value that is determined in the module process in the previous stage, the execution time may possibly greatly varies for each process. Namely, if the parameter that is used in each of the processes is decided, the arrangement decision unit 122 can estimate the execution time from the prior information; however, if the related time greatly varies due to a change in parameter or the content of data, the arrangement decision unit 122 estimates the execution time by using a method of, for example, statistically estimating the execution time from the past execution time.

Then, the arrangement decision unit 122 obtains, by using the partial reconfigurable regions 200 that are available for arranging the partial reconfigurable modules in the case where the reconfiguration time is hidden, the maximum operation frequency and the processing time taken to perform the second process in the case where arrangement is performed such that the lowest value of the maximum operation frequency becomes the highest. Here, the partial reconfigurable regions 200 that are available for arranging the partial reconfigurable modules when the reconfiguration time is hidden is the remaining partial reconfigurable regions 200 obtained by excluding the partial reconfigurable regions 200 in which the partial reconfigurable modules that are performing the processes are arranged.

Here, the arrangement decision unit 122 selects the selection candidates from the remaining partial reconfigurable regions 200 obtained by excluding the partial reconfigurable regions 200 in which the partial reconfigurable modules that are performing the processes are arranged and then performs the arrangement decision described in the first embodiment, whereby the arrangement decision unit 122 decides the arrangement in the case where the reconfiguration time is hidden. Furthermore, the arrangement decision unit 122 multiplies the execution time at the predetermined frequency by the ratio of the predetermined frequency to the obtained maximum operation frequency in the case where the reconfiguration time is hidden, whereby the arrangement decision unit 122 obtains the processing time of the second process in the case where the reconfiguration time is hidden.

Then, the arrangement decision unit 122 obtains, by using the partial reconfigurable regions 200 that are available for arranging the partial reconfigurable modules in the case where the reconfiguration time is not hidden, the maximum operation frequency and the processing time of the second process in the case where arrangement is performed such that the lowest value of the maximum operation frequency becomes the highest. Here, the partial reconfigurable regions 200 available for arranging the partial reconfigurable modules in the case where the reconfiguration time is not hidden are all of the partial reconfigurable regions 200 including the partial reconfigurable regions 200 in which the partial reconfigurable modules have been arranged in all of the processes.

Here, by selecting the selection candidates from all of the partial reconfigurable regions 200 and performing the arrangement decision described in the first embodiment, the arrangement decision unit 122 decides the arrangement in the case where the reconfiguration time is not hidden. Furthermore, the arrangement decision unit 122 multiplies the execution time at the predetermined frequency by the ratio of the predetermined frequency by the obtained maximum operation frequency in the case where the reconfiguration time is not hidden, whereby the arrangement decision unit 122 obtains the processing time of the second process in the case where the reconfiguration time is not hidden.

Then, the arrangement decision unit 122 sets the processing time taken to perform the second process in the case where the reconfiguration time is hidden to the reconfiguration hiding processing time. Furthermore, the arrangement decision unit 122 calculates the reconfiguration unhiding processing time by adding the estimated reconfiguration time to the processing time taken to perform the second process in the case where the calculated reconfiguration time is not hidden. Then, the arrangement decision unit 122 compares the reconfiguration hiding processing time with the reconfiguration unhiding processing time and selects the arrangement method needed shorter time.

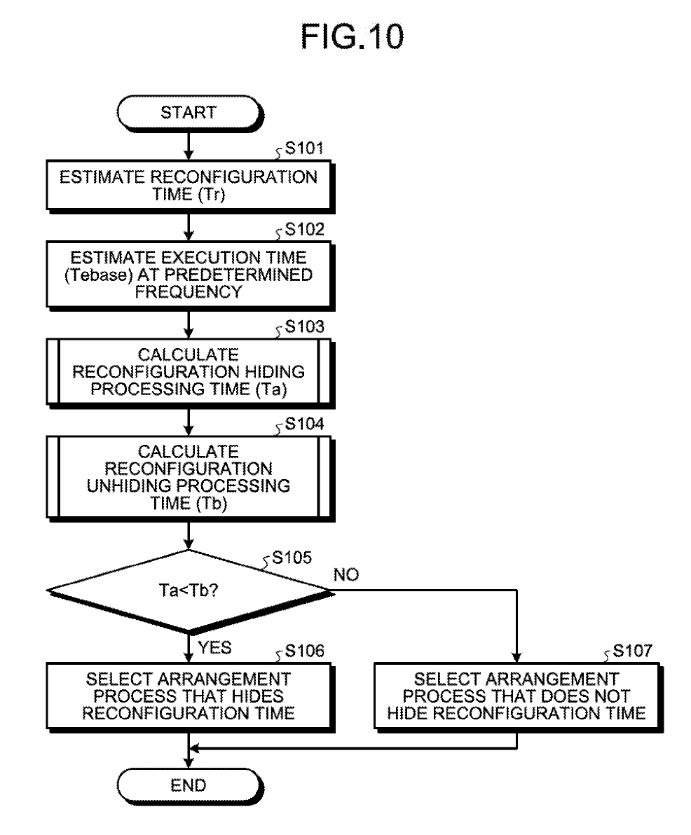

In the following, the flow of an arrangement decision process of the partial reconfigurable modules according to the embodiment will be described with reference to FIG. 10. FIG. 10 is a flowchart illustrating an arrangement decision process of a partial reconfigurable module according to a second embodiment.

The arrangement decision unit 122 acquires the type and the number of partial reconfigurable modules that perform the second process. Then, the arrangement decision unit 122 estimates the reconfiguration time taken by the partial reconfigurable modules that execute the second process (Step S101). Here, the reconfiguration time is represented by Tr.

Then, the arrangement decision unit 122 estimates the execution time at the predetermined frequency taken to perform the second process (Step S102). Here, execution time at the predetermined frequency taken to perform the second process is represented by Tebase.

Then, the arrangement decision unit 122 calculates the reconfiguration hiding processing time (Step S103). Here, the reconfiguration hiding processing time is represented by Ta. The reconfiguration hiding processing time will be described in detail later.

Then, the arrangement decision unit 122 calculates the reconfiguration unhiding processing time (Step S104). Here, the reconfiguration unhiding processing time is represented by Tb. The calculation process of the reconfiguration unhiding processing time will be described in detail later.

Then, the arrangement decision unit 122 determines whether the reconfiguration hiding processing time is shorter than the reconfiguration unhiding processing time, i.e., Ta<Tb is satisfied (Step S105).

If the reconfiguration hiding processing time is shorter than the reconfiguration unhiding processing time (Yes at Step S105), the arrangement decision unit 122 decides the arrangement process in the case where the reconfiguration time is hidden (Step S106). Thereafter, before the end of the running process, the arrangement decision unit 122 notifies the arrangement processing unit 121 of the decided arrangement. Before the end of the running process, the arrangement processing unit 121 arranges the partial reconfigurable modules in the partial reconfigurable regions 200 in accordance with the arrangement decided by the arrangement decision unit 122.

In contrast, if the reconfiguration hiding processing time is equal to or greater than the reconfiguration unhiding processing time (No at Step S105), the arrangement decision unit 122 decides to perform the arrangement process in the case where the reconfiguration time is not hidden (Step S107). After receiving the notification of the completion of the erasing from the erasing unit 123, the arrangement decision unit 122 notifies the arrangement processing unit 121 of the decided arrangement. The arrangement processing unit 121 arranges the partial reconfigurable modules in the partial reconfigurable regions 200 in accordance with the arrangement decided by the arrangement decision unit 122.

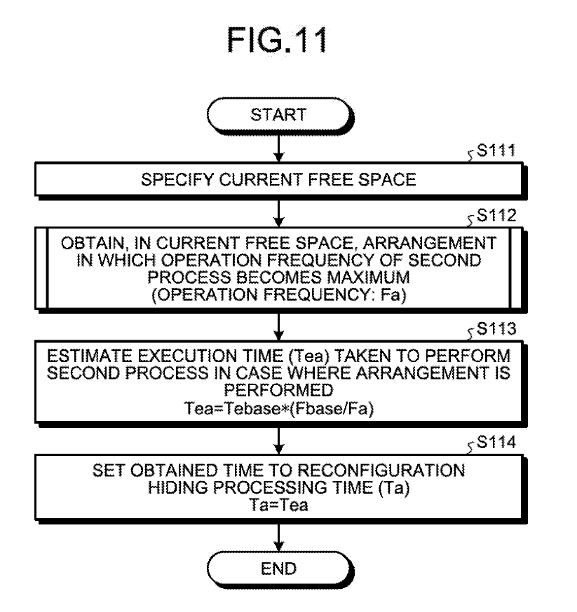

In the following, the flow of a calculation process of the reconfiguration hiding processing time will be described with reference to FIG. 11. FIG. 11 is a flowchart illustrating a calculation process of reconfiguration hiding processing time.

The arrangement decision unit 122 specifies, as the current free space, the remaining partial reconfigurable regions 200 obtained by excluding the partial reconfigurable regions 200 in which the partial reconfigurable modules that are performing the process from all of the partial reconfigurable regions 200 (Step S111).

Then, the arrangement decision unit 122 obtains, in the current free space, the arrangement in which the operation frequency of the second process becomes the maximum, i.e., the arrangement in which the lowest value of the maximum operation frequency becomes the highest (Step S112). The example of this process performed at Step S112 corresponds to the processes indicated by the flowchart illustrated in FIG. 6. However, the initial selection candidate setting process performed at Step S3 indicated in the flowchart illustrated in FIG. 6 is different from that described in the first embodiment. Then, regarding the process of setting the initial selection candidate in the case where the reconfiguration time is hidden will be described in detail later. Here, the operation frequency in the case where this arrangement is performed is represented by Fa.

Then, the arrangement decision unit 122 estimates the execution time taken to perform the second process in the case where the decided arrangement is performed (Step S113). Here, the execution time taken to perform the second process in the case where the decided arrangement is performed is represented by Tea. In this case, the arrangement decision unit 122 obtains, as Tea=Tebase#(Fbase/Fa), the execution time taken to perform the second process in the case where the decided arrangement is performed.

Then, the arrangement decision unit 122 sets the obtained execution time to the reconfiguration hiding processing time (Step S114). Namely, the arrangement decision unit 122 sets the state to Ta=Tea.

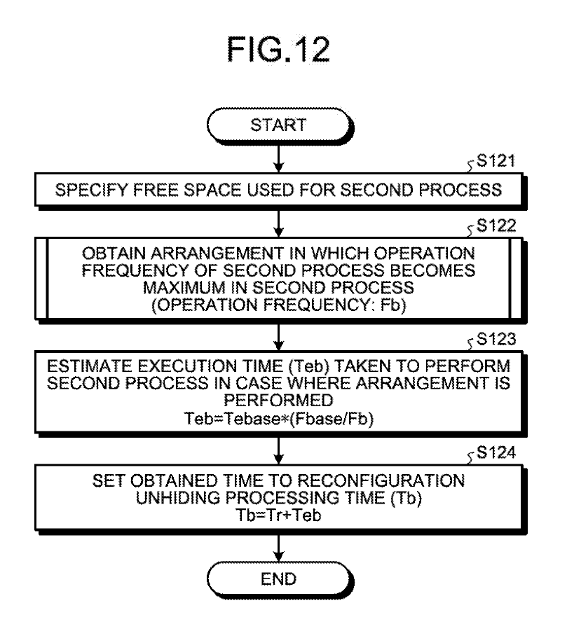

In the following, the flow of a calculation process of the reconfiguration unhiding processing time will be described with reference to FIG. 12. FIG. 12 is a flowchart illustrating a calculation process of reconfiguration unhiding processing time.

The arrangement decision unit 122 specifies all of the partial reconfigurable regions 200 as the free space used for the second process (Step S121).

Then, the arrangement decision unit 122 obtains the arrangement in which the operation frequency of the free space used for the second process becomes the maximum in the second process, i.e., the arrangement in which the lowest value of the maximum operation frequency becomes the highest (Step S122). The example of this process at Step S122 corresponds to the processes indicated by the flowchart illustrated in FIG. 6. Here, the number of the subject of operation in the case where this arrangement is performed is represented by Fb.

Then, the arrangement decision unit 122 estimates the execution time taken to perform the second process in the case where the decided arrangement is performed (Step S123). Here, the execution time taken to perform the second process in the case where the decided arrangement is performed is represented by Teb. In this case, the arrangement decision unit 122 obtains, as Teb=Tebase#(Fbase/Fb), the execution time of the second process in the case where the decided arrangement is performed.

Then, the arrangement decision unit 122 adds the estimated reconfiguration time to the obtained execution time and sets the addition result to the reconfiguration unhiding processing time (Step S124). Namely, the arrangement decision unit 122 sets the state to Tb=Tr+Teb.

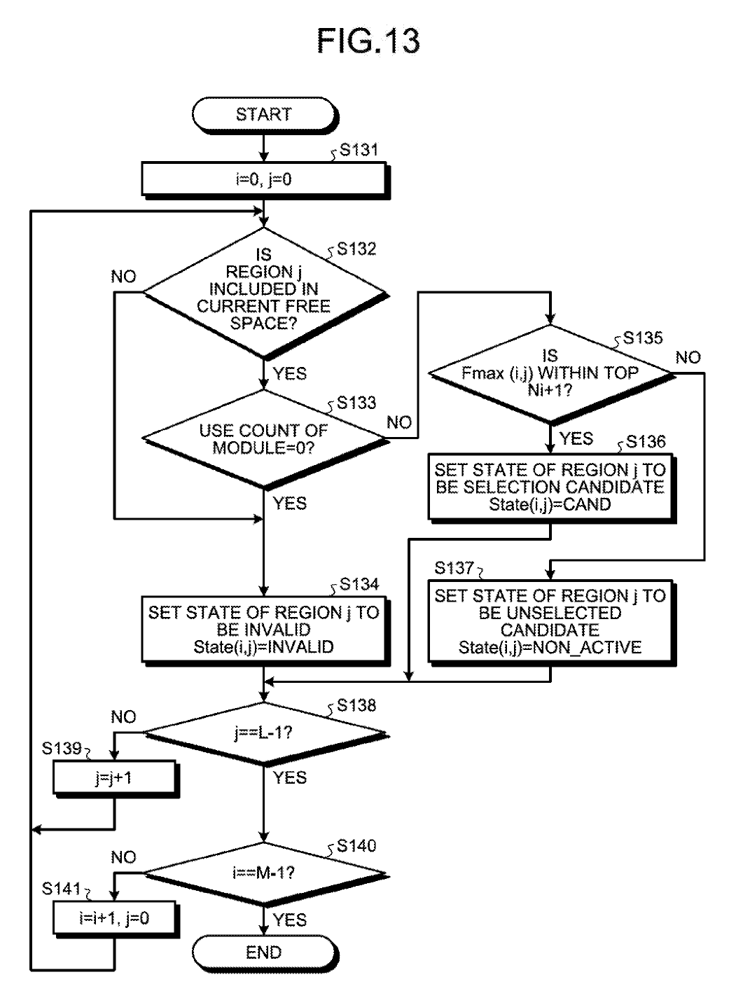

In the following, the flow of the process of setting the initial selection candidates in the case where the reconfiguration time is hidden will be described with reference to FIG. 13. FIG. 13 is a flowchart illustrating a process of setting an initial selection candidate when reconfiguration time is hidden. The processes indicated by the flowchart illustrated in FIG. 13 corresponds to an example of this process of setting the initial selection candidate included in the process performed at Step S112 illustrated in FIG. 11. Here, a description will be given in a case in which the number of unused partial reconfigurable modules is zero.

The module ID of the partial reconfigurable module is represented by i and the subject partial reconfigurable module is represented by the module i. Furthermore, the region ID of the partial reconfigurable region 200 is represented by j and the subject partial reconfigurable region 200 is represented by PRRj. Furthermore, the maximum operation frequency of the module i in PRRj is represented by Fmax (i,j).

The arrangement decision unit 122 sets the state to i=0 and j=0 (Step S131).

The arrangement decision unit 122 determines whether the region j is included in the current free space (Step S132). If the region j is not included in the current free space (No at Step S132), the arrangement decision unit 122 proceeds to Step S134.

In contrast, if the region j is included in the current free space (Yes at Step S132), the arrangement decision unit 122 determines whether the number of use counts of the module Ni=0 is satisfied, i.e., the module i is to be used in the second process (Step S133). If the number of use counts of the module Ni=0 is satisfied (Yes at Step S133), the arrangement decision unit 122 proceeds to Step S134.

Then, the arrangement decision unit 122 sets the state of the module i with respect to the region j to be invalid. Namely, the arrangement decision unit 122 sets the state to State (i,j)=INVALID (Step S134).

In contrast, if the number of use counts of the module Ni=0 is not satisfied (No at Step S133), the arrangement decision unit 122 determines whether Fmax (i,j) is within the number of use counts of the module Ni+1 counted in descending numeric order of Fmax (i,j) (Step S135). If Fmax (i,j) is within the top Ni+1 (Yes at Step S135), the arrangement decision unit 122 decides the state of the module i with respect to the region j to the selection candidate. Namely, the arrangement decision unit 122 sets the subject state to State (i,j)=CAND (Step S136).

In contrast, if Fmax (i,j) is not within the top Ni+1 (No at Step S135), the arrangement decision unit 122 decides the state of the module i with respect to the region j to the unselected candidate. Namely, the arrangement decision unit 122 sets the state to State (i,j)=NON_ACTIVE (Step S137).

Then, the arrangement decision unit 122 determines whether the decision of the state with respect to the module i has been performed on all of the partial reconfigurable regions 200. Namely, the arrangement decision unit 122 determines whether j=L−1 is satisfied (Step S138). If there are partial reconfigurable regions 200 in which the state with respect to the module i has not been decided (No at Step S138), the arrangement decision unit 122 increments the value of j by 1 (j=j+1) (Step S139) and returns to Step S132.

In contrast, the decision of the state with respect to the module i regarding all of the partial reconfigurable regions 200 has been completed (Yes at Step S138), the arrangement decision unit 122 determines, regarding all of the partial reconfigurable modules, whether the selection candidate has been specified. Namely, the arrangement decision unit 122 determines whether i=M−1 is satisfied (Step S140). If there are the partial reconfigurable modules in which the selection candidate has not been specified (No at Step S140), the arrangement decision unit 122 increments the value of i by 1 (i=i+1), sets the state to j=0 (Step S141), and then returns to Step S132.

In contrast, regarding all of the partial reconfigurable modules, the specification of the selection candidate has been completed (Yes at Step S140), the arrangement decision unit 122 ends the process of setting the initial selection candidates. Consequently, the arrangement decision unit 122 can decide the state of all of the partial reconfigurable regions 200 with respect to all of the partial reconfigurable modules.

Here, in FIG. 13, the state of the partial reconfigurable region 200 in which the partial reconfigurable module that is performing the process to be invalid; however, the arrangement decision unit 122 may also set the subject partial reconfigurable region 200 to be out of the target by setting the state, as the additional state, in which the subject partial reconfigurable region 200 is being used by another module.

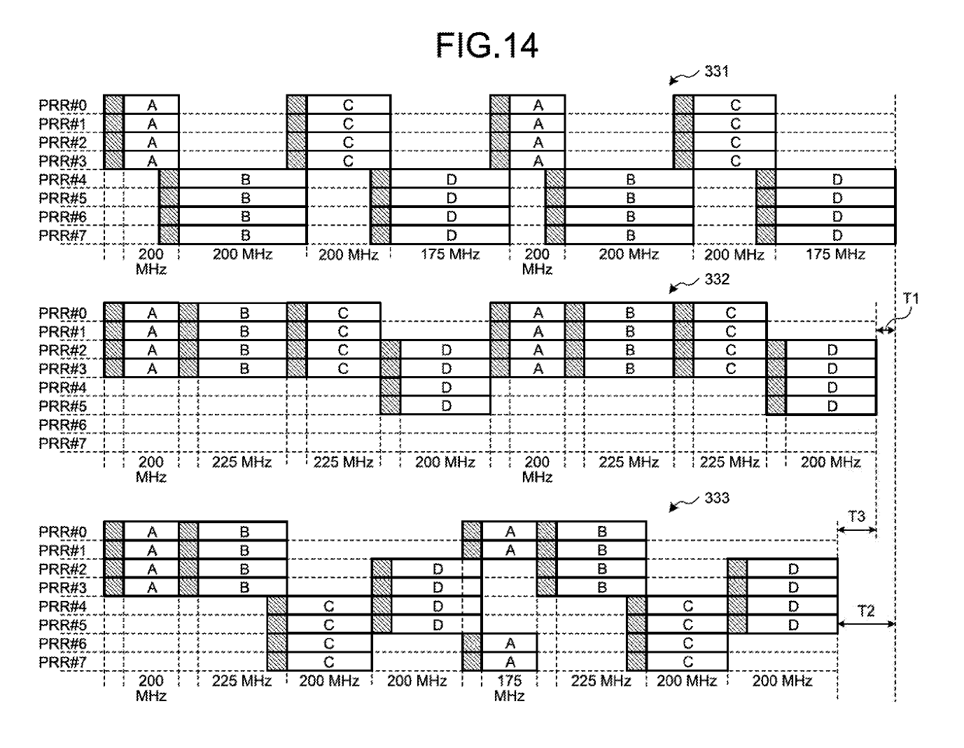

FIG. 14 is a timing chart for explaining the effect of a process performed by the partial reconfigurable module according to the second embodiment. Here, a description will be given in a case in which the partial reconfigurable modules are arranged by using the maximum operation frequency information table 141 illustrated in FIG. 4. A graph 331 illustrated in FIG. 14 is a graph in the case where the partial reconfigurable modules are arranged in ascending numerical order of the free partial reconfigurable region 200. A graph 332 is a graph in the case where the partial reconfigurable modules are arranged in the high-frequency partial reconfigurable regions 200. A graph 333 is a graph in the case where the reconfiguration time is hidden.

The arrangement decision unit 122 according to the embodiment compares, regarding the partial reconfigurable modules A to D, the processing time in the case where the reconfiguration time is hidden with the processing time in the case where the reconfiguration time is not hidden and then selects the module with shorter processing time. In this case, as indicated by the graphs 332 and 333, regarding the partial reconfigurable modules A, B, and D, the arrangement decision unit 122 selects the arrangement in which the reconfiguration time is not hidden. In contrast, regarding the partial reconfigurable module C, because the overall processing time can be reduced if the reconfiguration time is hidden even if the operation frequency of the partial reconfigurable module C is delayed, the arrangement decision unit 122 selects the arrangement in which the reconfiguration time is hidden. Furthermore, regarding the process performed on the partial reconfigurable modules A after processing the partial reconfigurable module D, because the overall processing time can be reduced if the reconfiguration time is hidden even if the operation frequency of the partial reconfigurable modules A are made to low, the arrangement decision unit 122 selects the arrangement in which the reconfiguration time is hidden.

If the partial reconfigurable modules are arranged in the high-frequency partial reconfigurable regions 200 as described in the first embodiment, as indicated by the graph 332, the processing time is reduced by time T1 compared with the case indicated by the graph 331. However, when considering that the reconfiguration time is hidden by using the method of arranging the partial reconfigurable modules according to the embodiment, as indicated by the graph 333, the processing time is reduced by time T2 compared with the case indicated by the graph 331. Namely, when using the method of arranging the partial reconfigurable modules according to the embodiment, it is possible to reduce the processing time by time T3 compared with the case in which the partial reconfigurable modules are arranged in the high-frequency partial reconfigurable regions 200.

As described above, the FPGA according to the embodiment obtains the execution time in the case where the reconfiguration time is not hidden and the execution time in the case where the reconfiguration time is hidden and performs the arrangement by selecting the arrangement process in which the processing time is short. Consequently, it is possible to further reduce the execution time.

### [c] Third Embodiment

In the following, a third embodiment will be described. An FPGA according to the embodiment differs from the first embodiment in that the arrangement of the partial reconfigurable modules in the second process is performed by considering the arrangement of the partial reconfigurable modules in the processes subsequent to the second process. Thus, in a description below, the function of deciding the arrangement of the partial reconfigurable modules will mainly be described. The server and the FPGA according to the embodiment are also indicated by FIGS. 1 to 3. In a description below, descriptions of units having the same functions as those performed in the first embodiment will be omitted.

The arrangement decision unit 122 estimates the reconfiguration time taken to arrange the partial reconfigurable modules that are used in the second process and the third process. Furthermore, the arrangement decision unit 122 estimates the execution time in a case of operating the partial reconfigurable modules that are to be used at the predetermined frequency in the second process and the third process.

Then, the arrangement decision unit 122 decides the arrangement of the partial reconfigurable modules in the second process and the third process in each of the combinations of cases, i.e., the case where the second process is hidden or not hidden and the case where the third process is hidden or not hidden, and obtains the processing time. However, if the combination has options, i.e., the priority is given to which one of the second process and the third process, the arrangement decision unit 122 obtains the arrangement and the processing time for each option. Here, the processing time is the time taken to complete the third process in a series of processes after the completion of the process in operation. Then, the arrangement decision unit 122 decides the arrangement in which the processing time is the smallest as the arrangement of the second process and the third process.

However, the arrangement decision unit 122 does not need to obtain the processing time of all of the combinations of cases, i.e., the case where the second process is hidden or not hidden and the case where the third process is hidden or not hidden. For example, the arrangement decision unit 122 may also obtain the arrangement and the processing time of previously determined combination. In the following, cases of using the typical three cases will be described.

The arrangement decision unit 122 obtains the processing time of the arrangement in which the reconfiguration time is hidden in both the second process and the third process and the priority is given to the second process. Specifically, the arrangement decision unit 122 decides the arrangement of the partial reconfigurable modules in the second process such that the operation frequency of the second process becomes the maximum in the current free space. Then, the arrangement decision unit 122 obtains the processing time of the second process in the case where the decided arrangement is used. Furthermore, the arrangement decision unit 122 excludes the partial reconfigurable regions 200 that are used by the decided arrangement in the second process from the current free space and obtains free space used for the third process. Then, the arrangement decision unit 122 decides the arrangement of the partial reconfigurable modules in the third process such that the operation frequency of the third process becomes the maximum in the obtained free space used for the third process. Then, the arrangement decision unit 122 obtains the processing time of the third process in the case where the decided arrangement is used. Thereafter, the arrangement decision unit 122 adds the obtained processing time of the second process and the obtained processing time of the third process and calculates the processing time in the case where the reconfiguration time is hidden in both the second process and the third process and in the case where the priority is given to the second process. In a description below, the arrangement in the case where the reconfiguration time is hidden in both the second process and the third process and in the case where the priority is given to the second process is referred to as the “second process priority hiding arrangement” and the processing time thereof is referred to as the “second process priority hiding processing time”.

Then, the arrangement decision unit 122 obtains the processing time of the arrangement in the case where the reconfiguration time is hidden in both the second process and the third process and the priority is given to the third process. Specifically, the arrangement decision unit 122 decides the arrangement of the partial reconfigurable modules in the third process such that the operation frequency of the third process becomes the maximum in the current free space. Then, the arrangement decision unit 122 obtains the processing time of the third process in the case where the decided arrangement is used. Furthermore, the arrangement decision unit 122 excludes the partial reconfigurable regions 200 that are used by the decided arrangement in the third process from the current free space and then obtains the free space used for the second process. Then, the arrangement decision unit 122 decides the arrangement of the partial reconfigurable modules in the second process such that the operation frequency of the second process becomes the maximum in the obtained free space used for the second process. Then, the arrangement decision unit 122 obtains the processing time of the second process in the case where the decided arrangement is used. Thereafter, the arrangement decision unit 122 adds the obtained processing time of the second process and the obtained processing time of the third process and calculates the processing time in the case where the reconfiguration time is hidden in both the second process and the third process and the priority is given to the third process. In a description below, the arrangement in the case where the reconfiguration time is hidden in both the second process and the third process and in the case where the priority is given to the third process is referred to as the “third process priority hiding arrangement” and the processing time thereof is referred to as the “third process priority hiding processing time”.

Then, the arrangement decision unit 122 obtains the processing time in the case where the reconfiguration time is not hidden in the second process and the reconfiguration time is hidden in the third process. Specifically, the arrangement decision unit 122 decides the arrangement of the partial reconfigurable modules in the second process such that the operation frequency of the second process using all of the partial reconfigurable regions 200 becomes the maximum. Then, the arrangement decision unit 122 obtains the processing time of the second process in the case where the decided arrangement is used. Furthermore, the arrangement decision unit 122 excludes the partial reconfigurable regions 200 in which the partial reconfigurable modules in the second process are arranged from all of the partial reconfigurable regions 200 and obtains the free space used for the third process. Then, the arrangement decision unit 122 decides the arrangement of the partial reconfigurable modules in the third process such that the operation frequency of the third process becomes the maximum in the obtained the free space used for the third process. Then, the arrangement decision unit 122 obtains the processing time of the third process in the case where the decided arrangement is used. Thereafter, the arrangement decision unit 122 adds the obtained processing time of the second process and the obtained processing time of the third process and calculates the processing time in the case where the reconfiguration time is not hidden in the second process and the reconfiguration time is hidden in the third process. In a description below, the arrangement in the case where the reconfiguration time is not hidden in the second process and the reconfiguration time is hidden in the third process is referred to as the “second process unhiding arrangement” and the processing time thereof is referred to as the “second process unhiding processing time”.

Then, the arrangement decision unit 122 specifies the shortest time from among the obtained second process priority hiding processing time, the third process priority hiding processing time, and the second process unhiding processing time. Then, the arrangement decision unit 122 decides the arrangement of the second process and the third process in accordance with the arrangement in which the specified processing time is satisfied.

Thereafter, after the start of the second process, the arrangement decision unit 122 similarly performs the process of deciding the arrangement of the third process and the process subsequent to the third process. However, the method of deciding the arrangement is not limited to this and, for example, the arrangement decision unit 122 may also decide, every two processes, the arrangement such that the decided arrangement of the third process is used without processing anything.

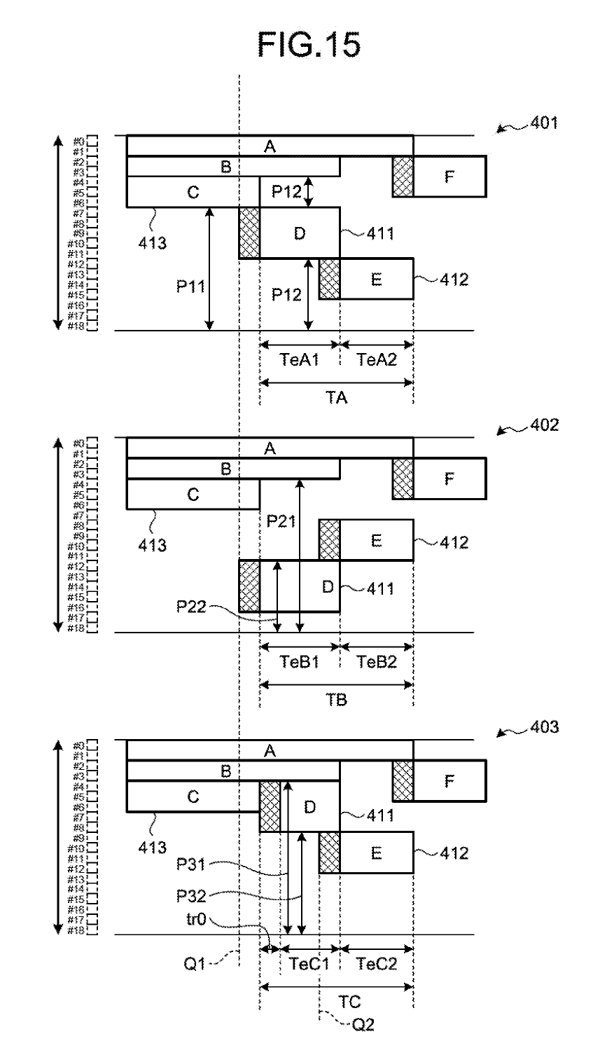

FIG. 15 is a schematic diagram illustrating processing time for each arrangement of the second process and the third process. A graph 401 is a graph representing the execution state of each of the processes in the case where the partial reconfigurable modules are arranged in the second process priority hiding arrangement. A graph 402 is a graph representing the execution state of each of the processes in the case where the partial reconfigurable modules are arranged in the third process priority hiding arrangement. A graph 403 is a graph representing the execution state of each of the processes in the case where the partial reconfigurable modules are arranged in the second process unhiding arrangement. In FIG. 15, the processes A and B can be operated in parallel with the processes C to F. Namely, when arranging the partial reconfigurable modules that perform the processes C to F, the arrangement is performed, in the case where the process can be performed in parallel with the processes A and B, while excluding the partial reconfigurable regions that are used by the processes A and B. Furthermore, the processes C to F are a series of processes. Namely, the processes C to F are performed after the end of each of the previous processes.

Here, a description will be given with the assumption that the process D is a second process 411, the process E is a third process 412, and the process C is a process 413 that is being performed. Namely, here, a description will be given of a case in which, in the state in which the process C is being performed, the arrangement of the partial reconfigurable modules in the processes D and E is decided. Furthermore, here, a description will be given of a case in which 19 partial reconfigurable regions 200, i.e., regions #0 to #18, are present. The partial reconfigurable modules that perform the process A are arranged in the regions #0 and #1 and the partial reconfigurable modules that perform the process B are arranged in the regions #2 to #3. Furthermore, the partial reconfigurable modules that perform the process C are arranged in the regions #4 to #6.

In a case of the second process priority hiding arrangement, as indicated by the graph 401, a region P11 is an available region as the arrangement destination of the partial reconfigurable modules that perform the process D. First, the partial reconfigurable modules that perform the process D are arranged such that the arrangement is performed in parallel with the process C and the operation frequency becomes the maximum by using the region P11. In this case, the partial reconfigurable modules that perform the process D are arranged in the regions #7 to #11. Furthermore, if the process D is started, the regions #4 to #6 in which the partial reconfigurable modules that perform the process C are arranged become available. Thus, a region P12 becomes an available region as the arrangement destination of the partial reconfigurable modules that perform the process E. The partial reconfigurable modules that perform the process E are arranged such that the arrangement is performed in parallel with the process D and the operation frequency becomes the maximum by using the region P12. In this case, the partial reconfigurable modules that perform the process E are arranged in the regions #12 to #15. In this case, the processing time of the process D is TeA1 and the processing time of the process E is TeA2. Thus, the processing time in this case is TA that is obtained by adding TeA1 and TeA2.

Furthermore, in a case of the second process priority hiding arrangement, as indicated by the graph 402, a region P21 is an available region as the arrangement destination of the partial reconfigurable modules that performs the process E. First, the partial reconfigurable modules that perform the process E are arranged such that the operation frequency becomes the maximum by using the region P21. In this case, the partial reconfigurable modules that perform the process E are arranged in the regions #7 to #10. Furthermore, because the arrangement of the process E is performed in parallel with the process D and the arrangement of the process B is performed in parallel with the process C, a region P22 that is other than the region in which the partial reconfigurable modules that perform the process C and the process E are arranged becomes the available region as the arrangement destination of the partial reconfigurable modules that perform the process D. Thus, the partial reconfigurable modules that perform the process B such that the operation frequency becomes the maximum by using the region P22. In this case, the partial reconfigurable modules that perform the process D are arranged in the regions #11 to #15. In this case, the processing time of the process D is TeB1 and the processing time of the process E is TeB2. Thus, the processing time in this case is TB obtained by adding TeB1 and TeB2.

Furthermore, in a case of the second process unhiding arrangement, as indicated by the graph 403, because the process B is arranged after the end of the process C, a region P31 is the available region as the arrangement destination of the partial reconfigurable modules that perform the process B. Thus, the partial reconfigurable modules that perform the process B are arranged such that the operation frequency becomes the maximum by using the region P31. In this case, because the reconfiguration of the partial reconfigurable modules that perform the process B is performed after the end of the process C, the subject time tr0 has elapsed. In this case, the partial reconfigurable modules that perform the process B are arranged in the regions #4 to #8. Furthermore, because the arrangement of the process E is performed in parallel with the process D, a region P32 that is other than the region in which the partial reconfigurable modules that perform the process D are arranged becomes the available region as the arrangement destination of the partial reconfigurable modules that perform the process E. Thus, the partial reconfigurable modules that perform the process E are arranged such that the operation frequency becomes the maximum by using the region P32. In this case, the partial reconfigurable modules that perform the process E are arranged in the regions #9 to #12. In this case, the processing time of the process D is TeC1 and the processing time of the process E is TeC2. Thus, the processing time in this case is TC that is obtained by adding tr0, TeC1, and TeC2.

Thus, the arrangement decision unit 122 compares TA to TC and selects the arrangement in which the processing time is the shortest. Furthermore, in this case, the arrangement decision unit 122 decides the arrangement of the partial reconfigurable modules that perform the processes B and E in timing Q1. However, the arrangement of the partial reconfigurable modules that perform the process E that is the third process 412 is tentative decision and, in timing Q2, the arrangement decision unit 122 decides the arrangement of the partial reconfigurable modules that perform the processes E and F by considering the state of the processes E and F. Then, in the timing Q2, the arrangement decision unit 122 decides the arrangement of the partial reconfigurable modules that perform the process E.

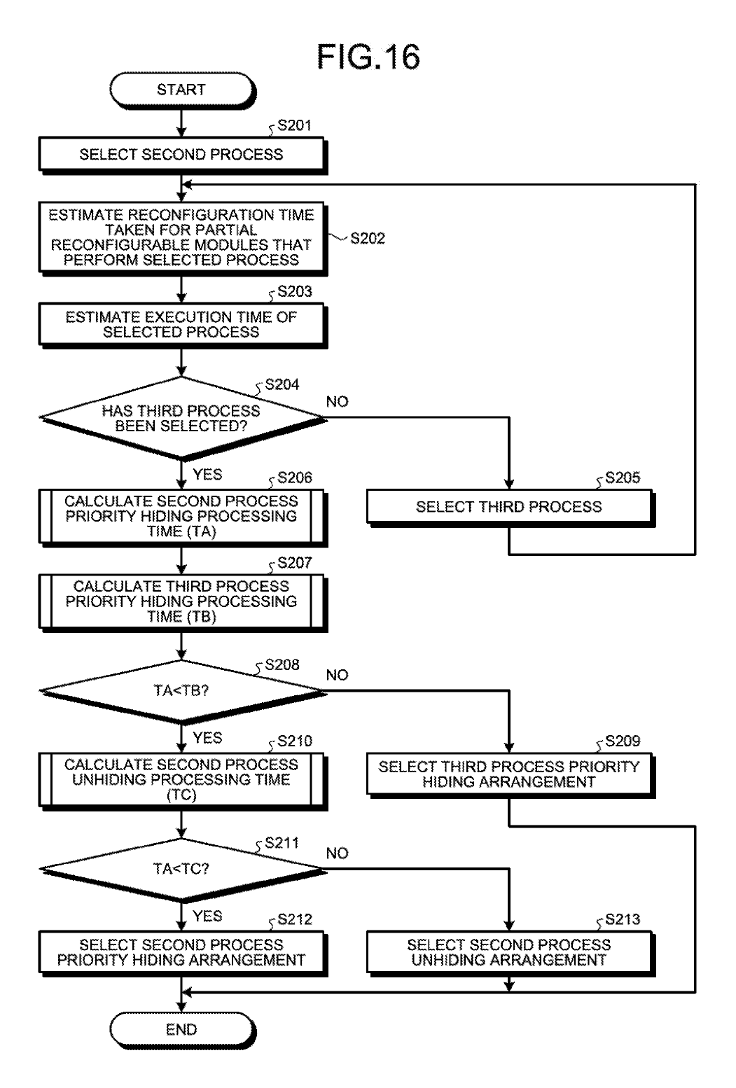

In the following, the flow of an arrangement decision process performed by the partial reconfigurable modules according to the embodiment will be described with reference to FIG. 16. FIG. 16 is a flowchart illustrating an arrangement decision process of the partial reconfigurable modules according to a third embodiment.

The arrangement decision unit 122 acquires the type and the number of partial reconfigurable modules that are arranged in the second process and the third process. Then, the arrangement decision unit 122 selects the second process (Step S201).

Then, the arrangement decision unit 122 estimates the reconfiguration time of the partial reconfigurable modules that perform the selected process (Step S202).

Then, the arrangement decision unit 122 estimates the execution time of the second process performed at the predetermined frequency (Step S203).

Then, the arrangement decision unit 122 determines whether the third process has been selected (Step S204). If the third process has not been selected (No at Step S204), the arrangement decision unit 122 selects the third process (Step S205) and returns to Step S201. Here, the reconfiguration execution time of the second process is represented by Tr1 and the reconfiguration execution time of the third process is represented by Tr2. Furthermore, the execution time of the second process at the predetermined frequency is represented by Tebase1 and the execution time of the third process at the predetermined frequency is represented by Tebase2.

In contrast, if the third process has been selected (Yes at Step S204), the arrangement decision unit 122 calculates the second process priority hiding processing time (Step S206). Here, the second process priority hiding processing time is represented by TA. The calculation process of the second process priority hiding processing time will be described in detail later.

Then, the arrangement decision unit 122 calculates the third process priority hiding processing time (Step S207). Here, the third process priority hiding processing time is represented by TB. The calculation process of the third process priority hiding processing time will be described in detail later.

Then, the arrangement decision unit 122 determines whether the second process priority hiding processing time is smaller than the third process priority hiding processing time, i.e., TA<TB is satisfied (Step S208).

If the second process priority hiding processing time is equal to or greater than the third process priority hiding processing time (No at Step S208), the arrangement decision unit 122 selects the third process priority hiding arrangement (Step S209). Then, before the end of the process in execution, the arrangement decision unit 122 notifies the arrangement processing unit 121 of the arrangement of the partial reconfigurable modules that perform the decided second process. The arrangement processing unit 121 arranges, before the end of the process in execution, the partial reconfigurable modules in the partial reconfigurable regions 200 in accordance with the arrangement decided by the arrangement decision unit 122.

In contrast, if the second process hiding processing time is shorter than the third process hiding processing time (Yes at Step S208), the arrangement decision unit 122 calculates the second process unhiding processing time (Step S210). Here, the second process unhiding processing time is represented by TC. The calculation process of the second process unhiding processing time will be described in detail later.

Then, the arrangement decision unit 122 determines whether the second process priority hiding processing time is shorter than the second process unhiding processing time, i.e., TA<TC is satisfied (Step S211).

If the second process priority hiding processing time is shorter than the second process unhiding processing time (Yes at Step S211), the arrangement decision unit 122 selects the second process priority hiding arrangement (Step S212). Then, before the end of the process in execution, the arrangement decision unit 122 notifies the arrangement processing unit 121 of the arrangement of the partial reconfigurable modules that perform the decided second process. The arrangement processing unit 121 arranges, before the end of the process in execution, the partial reconfigurable modules in the partial reconfigurable regions 200 in accordance with the arrangement decided by the arrangement decision unit 122.

In contrast, if the second process priority hiding processing time is equal to or greater than the second process unhiding processing time (No at Step S211), the arrangement decision unit 122 selects the second process unhiding arrangement (Step S213). After the notification of the completion of the erasing is received from the erasing unit 123, the arrangement decision unit 122 notifies the arrangement processing unit 121 of the arrangement of the partial reconfigurable modules that perform the decided second process. The arrangement processing unit 121 arranges the partial reconfigurable modules in the partial reconfigurable regions 200 in accordance with the arrangement decided by the arrangement decision unit 122.

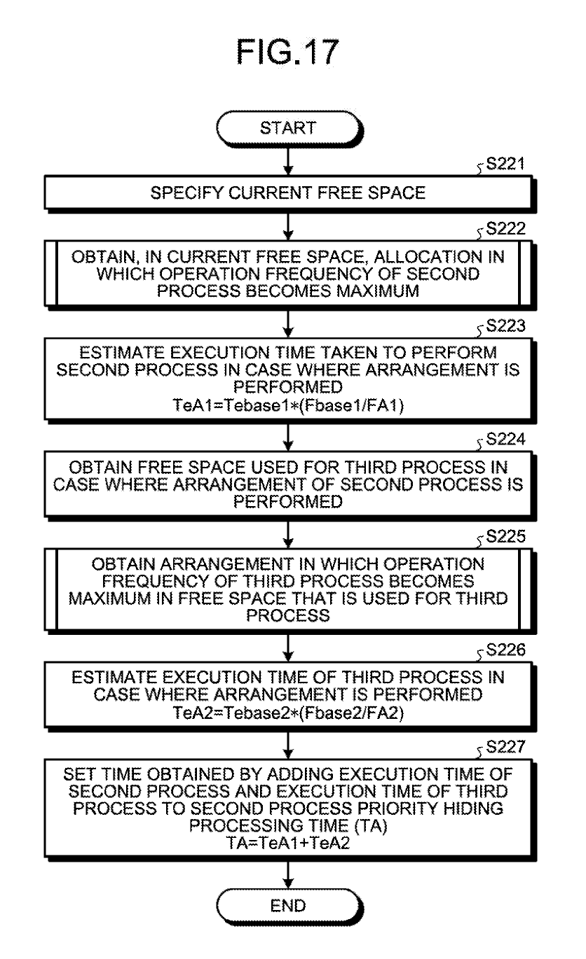

In the following, the flow of a calculation process of the second process priority hiding processing time will be described with reference to FIG. 17. FIG. 17 is a flowchart illustrating a calculation process of the second process priority hiding processing time.

The arrangement decision unit 122 specifies, as the current free space, the remaining partial reconfigurable regions 200 obtained by excluding the partial reconfigurable regions 200 in which the partial reconfigurable modules that are performing the process from all of the partial reconfigurable regions 200 (Step S221).

Then, the arrangement decision unit 122 obtains the arrangement in which the operation frequency of the second process becomes the maximum in the current free space, i.e., the lowest value of the maximum operation frequency becomes the highest (Step S222). The example of this process at Step S222 corresponds to the processes indicated by the flowchart illustrated in FIG. 6. However, the initial selection candidate setting process at Step S3 indicated by the flowchart illustrated in FIG. 6 uses the process indicated by the flowchart illustrated in FIG. 13. Here, the operation frequency of the second process in the case where the decided arrangement is performed is represented by FA1.

Then, the arrangement decision unit 122 estimates the execution time of the second process in the case where the decided arrangement is performed (Step S223). Here, the execution time of the second process in the case where the decided arrangement is performed is represented by TeA1. In this case, the arrangement decision unit 122 obtains, as TeA1=Tebase1*(Fbase1/FA1), the execution time of the second process in the case where the second process priority hiding arrangement is performed.

Then, the arrangement decision unit 122 obtains the free space used for the third process in the case where the arrangement of the decided second process is performed (Step S224).

Then, the arrangement decision unit 122 obtains the arrangement in which the operation frequency of the third process becomes the maximum in the free space that is used for the third process, i.e., the arrangement in which the lowest value of the maximum operation frequency becomes the highest (Step S225). The example of this process at Step S225 corresponds to the processes indicated by the flowchart illustrated in FIG. 6. However, the initial selection candidate setting process performed at Step S3 indicated by the flowchart illustrated in FIG. 6 uses the process indicated by the flowchart illustrated in FIG. 13. Here, the operation frequency of the third process in the case where the decided arrangement is performed is represented by FA2.

Then, the arrangement decision unit 122 estimates the execution time of the third process in the case where the decided arrangement is performed (Step S226). Here, the execution time of the third process in the case where the decided arrangement is performed is represented by TeA2. In this case, the arrangement decision unit 122 obtains, as TeA2=Tebase2*(Fbase2/FA2), the execution time of the third process in the case where the second process priority hiding arrangement is performed.

Then, the arrangement decision unit 122 adds the execution time of the second process to the execution time of the third process in the case where the second process priority hiding arrangement is performed and sets the obtained result as the second process priority hiding processing time (Step S227). Namely, the arrangement decision unit 122 obtains the result of TA=TeA1+TeA2.

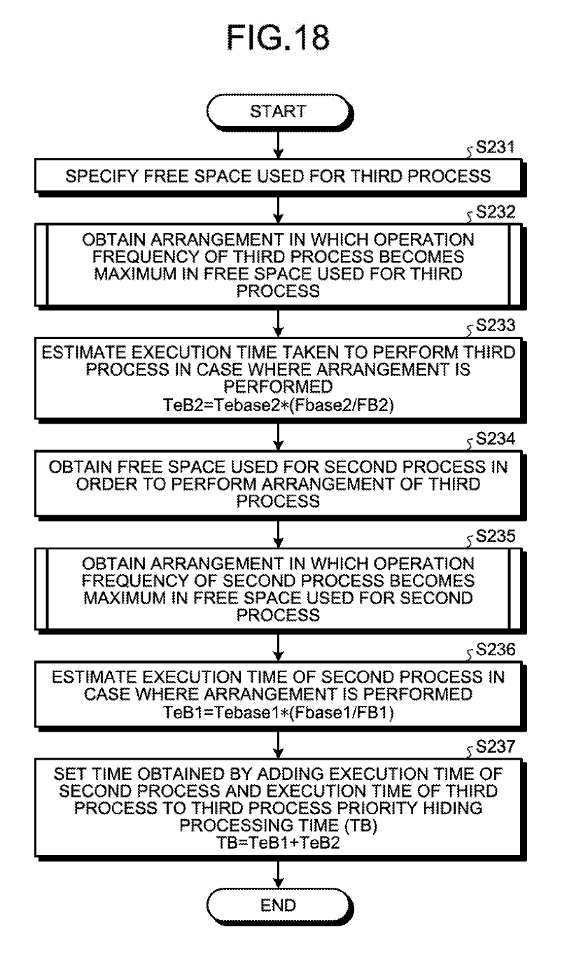

In the following, the flow of a calculation process of the third process priority hiding processing time will be described with reference to FIG. 18. FIG. 18 is a flowchart illustrating a calculation process of the third process priority hiding processing time.

The arrangement decision unit 122 specifies, as the free space used for the third process, the remaining partial reconfigurable regions 200 obtained by excluding the partial reconfigurable regions 200 in which the partial reconfigurable modules that are performing the process from all of the partial reconfigurable regions 200 (Step S231).

Then, the arrangement decision unit 122 obtains the arrangement in which the operation frequency of the third process becomes the maximum in the free space used for the third process, i.e., the lowest value of the maximum operation frequency becomes the highest (Step S232). The example of this process at Step S232 corresponds to the processes indicated by the flowchart illustrated in FIG. 6. However, the initial selection candidate setting process performed at Step S3 indicated by the flowchart illustrated in FIG. 6 uses the process indicated by the flowchart illustrated in FIG. 13. Here, the operation frequency of the partial reconfigurable modules that perform the second process in the case where the decided arrangement has been performed is represented by FB2.

Then, the arrangement decision unit 122 estimates the execution time of the third process in the case where the decided arrangement is performed (Step S233). Here, the execution time of the third process in the case where the decided arrangement has been performed is represented by TeB2. In this case, the arrangement decision unit 122 obtains, as TeB2=Tebase2*(Fbase2/FB2), the execution time of the third process in the case where the third process priority hiding arrangement is performed.

Then, in order to perform the arrangement of the decided third process, the arrangement decision unit 122 obtains the free space used for the second process by excluding the partial reconfigurable regions 200 that perform the second process from the free space used for the third process (Step S234).

Then, the arrangement decision unit 122 obtains the arrangement in which the operation frequency of the second process becomes the maximum in the free space used for the second process, i.e., the lowest value of the maximum operation frequency becomes the highest (Step S235). The example of this process at Step S235 corresponds to the processes indicated by the flowchart illustrated in FIG. 6. However, the initial selection candidate setting process performed at Step S3 indicated by the flowchart illustrated in FIG. 6 uses the process indicated by the flowchart illustrated in FIG. 13. Here, the operation frequency of the third process in the case where the decided arrangement is performed is represented by FB1.

Then, the arrangement decision unit 122 estimates the execution time of the second process in the case where the decided arrangement is performed (Step S236). Here, the execution time of the second process in the case where the decided arrangement is performed. In this case, the arrangement decision unit 122 obtains, as TeB1=Tebase1#(Fbase1/FB1), the processing time of the third process in the case where the third process priority hiding arrangement is performed.

Then, the arrangement decision unit 122 adds the execution time of the second process and the execution time of the third process in the case where the third process priority hiding arrangement is performed and sets the obtained result to the third process priority hiding processing time (Step S237). Namely, the arrangement decision unit 122 obtains the result of TB=TeB1+TeB2.

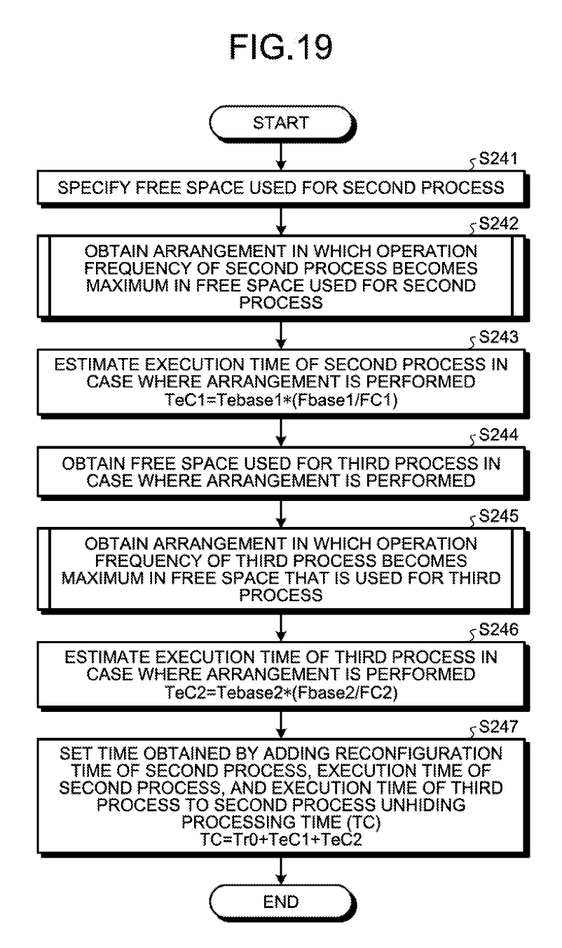

In the following, the flow of a calculation process of the second process unhiding processing time will be described with reference to FIG. 19. FIG. 19 is a flowchart illustrating a calculation process of the second process unhiding processing time.

The arrangement decision unit 122 specifies all of the partial reconfigurable regions 200 as the free space used for the second process (Step S241). Here, all of the partial reconfigurable regions 200 are available regions in the case where none of the partial reconfigurable modules that perform a series of processes are arranged in the partial reconfigurable regions 200 is arranged.

Then, the arrangement decision unit 122 obtains the arrangement in which the operation frequency of the second process becomes the maximum in the free space used for the second process, i.e., the lowest value of the maximum operation frequency becomes the highest (Step S242). The example of this process at Step S242 corresponds to the process indicated by the flowchart illustrated in FIG. 6. Here, the operation frequency of the second process in the case where the decided arrangement is performed is represented by FC1.

Then, the arrangement decision unit 122 estimates the execution time of the second process in the case where the decided arrangement is performed (Step S243). Here, the execution time of the second process in the case where the decided arrangement is performed is represented by TeC1. In this case, the arrangement decision unit 122 obtains, as TeC1=Tebase1*(Fbase1/FB1), the execution time of the second process in the case where the second process unhiding arrangement is performed.

Then, the arrangement decision unit 122 obtains the free space used for the third process by excluding, from the free space that is used for the second process, the partial reconfigurable regions 200 in which the decided partial reconfigurable modules of the second process are arranged (Step S244).

Then, the arrangement decision unit 122 obtains the arrangement in which the operation frequency of the third process becomes the maximum in the free space that is used for the third process, i.e., the lowest value of the maximum operation frequency becomes the maximum (Step S245). The example of this process at Step S245 corresponds to the processes indicated by the flowchart illustrated in FIG. 6. However, the initial selection candidate setting process at Step S3 indicated by the flowchart illustrated in FIG. 6 uses the process indicated by the flowchart illustrated in FIG. 13. Here, the operation frequency in the case where the second process unhiding arrangement is performed is represented by FC2.

Then, the arrangement decision unit 122 estimates the execution time of the third process in the case where the decided arrangement is performed (Step S246). Here, the execution time of the third process in the case where the decided arrangement is performed is represented by TeC2. In this case, the arrangement decision unit 122 obtains, as TeC2=Tebase2#(Fbase2/FC2), the processing time of the third process in the case where the second process unhiding arrangement is performed.

Then, the arrangement decision unit 122 adds the reconfiguration time of the second process, the execution time of the second process, and the execution time of the third process in the case where the second process unhiding arrangement is performed and sets the obtained result to the second process unhiding processing time (Step S247). Namely, the arrangement decision unit 122 sets the state to TC=Tr0+TeC1+TeC2.

As described above, the FPGA according to the embodiment considers, in also the process subsequent to the second process, a case in which the reconfiguration time is not hidden and a case in which the reconfiguration time is hidden and can perform the arrangement by selecting the arrangement process with smaller processing time. Consequently, it is possible to further reduce the processing time.

According to an aspect of an embodiment of the information processing apparatus, the information processing system, the information processing program, and the information processing method disclosed in the present invention, an advantage is provided in that it is possible to improve the operation frequency of each of the functional modules in the FPGA.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a plurality of partial reconfigurable regions that performs processes by using, from among a plurality of functional modules, the functional module that is arranged in each of the partial reconfigurable regions, respectively;
an arrangement decision unit that decides the arrangement of the functional module into each of the partial reconfigurable regions on the basis of the maximum operation frequency for each of the partial reconfigurable regions in a case where each of the functional modules is arranged in the partial reconfigurable regions; and
an arrangement processing unit that arranges the functional modules in the partial reconfigurable regions on the basis of the arrangement decided by the arrangement decision unit.

2. The information processing apparatus according to claim 1, wherein the arrangement decision unit decides the arrangement of each of the functional modules into the partial reconfigurable regions such that the lowest value of the maximum operation frequency in a case where each of the functional modules is arranged in the partial reconfigurable regions becomes the highest.

3. The information processing apparatus according to claim 1, wherein
the arrangement decision unit acquires arrangement candidates, each of which is a combination of the partial reconfigurable region and the type of the functional module, in the order the maximum operation frequency is high, and
when the arrangement is performed on the arrangement candidates each having the combination of the acquired partial reconfigurable region and the acquired type of the functional module and when the functional module with a different type is overlapped in a specific partial reconfigurable region as the arrangement candidate, the arrangement decision unit decides, in the specific partial reconfigurable region, the arrangement of the functional module with the type having the highest value of the maximum operation frequency in a case where the functional modules with different types are arranged in the partial reconfigurable regions other than already-arranged regions in which the arrangement of the functional modules has been completed.

4. The information processing apparatus according to claim 1, further comprising an erasing unit that invalidates, when unused regions are present from among the already-arranged regions in which the arrangement of the functional modules has been completed and when completion regions in which the processes have been completed by the functional modules are present in the already-arranged regions, the functional modules arranged in the completion regions as the unused regions and that creates, from the unused regions, the partial reconfigurable regions in which the functional modules can be arranged.

5. The information processing apparatus according to claim 4, wherein, when the already-arranged regions are present at the time of arrangement decision, the arrangement decision unit decides the arrangement of the functional modules on the basis of hiding processing time taken for the arrangement that is performed by using the partial reconfigurable regions other than the already-arranged regions and on the basis of unhiding processing time taken for the arrangement that is performed by using the partial reconfigurable regions in which the functional modules created from the already-arranged regions by the erasing unit can be arranged.

6. The information processing apparatus according to claim 4, wherein, regarding arrangement, in a plurality of processes sequentially performed through stages, of the functional modules used in each of the processes into each of the partial reconfigurable regions, the arrangement decision unit decides the arrangement on the basis of, at the time of arrangement decision in each of the stages up to a predetermined stage after a second stage in the processes, the hiding processing time taken for the arrangement that is performed by using the partial reconfigurable regions other than the already-arranged regions and the unhiding processing time taken for the arrangement that is performed by using the partial reconfigurable regions in which the functional modules created from the already-arranged region by the erasing unit can be arranged such that the processing time is the shortest when the processes up to the predetermined stage are performed.

7. An information processing system comprising:
an arithmetic processing unit;
a plurality of partial reconfigurable regions that performs processes in cooperation with the arithmetic processing unit by using, from among a plurality of functional modules, the functional module that is arranged in each of the partial reconfigurable regions, respectively;
a storage unit that stores, in each of the partial reconfigurable regions, the maximum operation frequency in a case where each of the functional modules is arranged in the partial reconfigurable regions;
an arrangement decision unit that decides, on the basis of the maximum operation frequencies stored in the storage unit, the arrangement of the functional module into each of the partial reconfigurable regions; and
an arrangement processing unit that arranges the functional modules in the partial reconfigurable regions on the basis of the arrangement decided by the arrangement decision unit.

8. An information processing method comprising:
storing, in each of a plurality of partial reconfigurable regions, the maximum operation frequency in a case where a plurality of functional modules is arranged in each of the predetermined partial reconfigurable regions;
deciding, on the basis of the stored maximum operation frequencies, the arrangement of the functional module into each of the partial reconfigurable regions;
arranging, on the basis of the decided arrangement, the functional module into each of the partial reconfigurable regions; and
performing processes by using the partial reconfigurable regions in each of which the functional module is arranged.

9. A non-transitory computer-readable recording medium having stored therein an information processing program that causes a computer to execute a process comprising:
storing, in each of a plurality of partial reconfigurable regions, the maximum operation frequency in a case where a plurality of functional modules is arranged in each of the predetermined partial reconfigurable regions;
deciding, on the basis of the stored maximum operation frequencies, the arrangement of the functional module into each of the partial reconfigurable regions;
arranging, on the basis of the decided arrangement, the functional module into each of the partial reconfigurable regions; and
performing processes by using the partial reconfigurable regions in each of which the functional module is arranged.
